(19) United States
(12) Patent Application Publication
(10) Pub. No.: US 2016/0345260 A1
(43) Pub. Date: Nov. 24, 2016

(54) Self Powered Device and Methods Conserving Energy in Communication

(71) Applicant: INVENT.LY LLC, Woodside, CA (US)

(72) Inventors: Brian Cory Johnson, Woodside, CA (US); Hector H Gonzalez-Banos, Mountain View, CA (US); Stephen J Brown, Woodside, CA (US)

(73) Assignee: INVENT.LY LLC, Woodside, CA (US)

(21) Appl. No.: 14/717,135

(22) Filed: May 20, 2015

(51) Int. Cl. H04W 52/02; H04N 5/232

(52) U.S. Cl. CPC H04W 52/0209; H04N 5/23206

(57) ABSTRACT

A device has a processor, a memory system coupled to the processor, an on-board, rechargeable power supply, one or more data-capture mechanisms, circuitry enabling wireless data transmission on a network, rules and criteria stored in the memory system regarding characteristics of data, and coded instructions executing on the processor from a non-transitory physical medium, providing a process wherein data captured by the one or more data-capture mechanisms is examined applying the rules and criteria regarding characteristics of data, and data is transmitted via the network by specific processes selected depending on the characteristics, the specific data transmission processes enabled to minimize power consumption in transmission.

### CROSS-REFERENCE TO RELATED DOCUMENTS

The instant application is related to application Ser. No. 14/169,464 “Predictive Power Management in a Wireless Sensor Network” filed Jan. 31, 2014, which is related to U.S. Ser. No. 14/103,209, filed Dec. 11, 2013, which is related to U.S. Ser. No. 13/946,414, filed Jul. 19, 2013, which is related to U.S. Ser. No. 13/406,469, filed Feb. 27, 2012, now U.S. Pat. No. 8,516,279, which is related to U.S. Ser. No. 12/472,327, filed May 25, 2009, now U.S. Pat. No. 8,127,158, which is related to U.S. Ser. No. 11/443,668, filed May 30, 2006, now U.S. Pat. No. 7,539,882, which is related to U.S. Provisional Application No. 60/685,976, filed May 30, 2005. The instant application also is related to application Ser. No. 11/443,668 “Self-powered devices and methods” filed May 30, 2006, now U.S. Pat. No. 7,539,882, to U.S. Ser. No. 14/090,099, filed Nov. 26, 2013, and to Provisional Application 60/685,976 “Self-powered devices and methods” filed May 30, 2005. The disclosure of all of the listed applications and patents is incorporated in the instant application at least by reference.

### BACKGROUND OF THE INVENTION

1. Field of the Invention

The present invention is in the field of wireless data communication over a network and pertains particularly to methods and apparatus for compressing data for transmission by self powered devices.

2. Discussion of the State of the Art

In the field of wireless network communication there are many systems that employ one or more self-powered devices that collect and transmit data, or that may forward received data to one or more other nodes in a network. Examples of such systems include automation devices in buildings, HVAC controls, security systems, cameras, drones, environmental sensors, health monitoring devices, musical instruments, monitors and displays and other tools and equipment, video/audio monitor systems, motion monitoring systems, medical monitoring systems, smart home networks, environmental state monitoring systems and many other types of state monitoring systems where one or more self-powered devices (SPDs) are employed to transmit certain data collected during a monitoring process.

The phrase “self-powered” means that the device may at times rely solely on its own local power source to operate and transmit data over a wireless channel to another device or node on the network. A self-powered state monitoring device may include a rechargeable energy storage device like a rechargeable battery. A SPD may also comprise a voltaic cell or solar cell energy collector to derive power from the sun.

It is generally understood in the art that SPDs consume energy while transmitting data to a receiver node on a wireless network or over a direct wireless channel. Energy consumption in a SPD is a function of many factors including amount of data or resolution of data transmitted, frequency of data transmission, and distance of the SPD from a remote receiver or hub. The priority of data transmitted to a receiver from a SPD may depend on the context of the data and its intended use. One transmission of data from a SPD may contain both high and low priority data.

In current wireless systems, there are compression methods known in the art to compress data overall for data transmission over a network. One example of this is moving pictures expert group (MPEG) for compressing video and audio for transmission over a network. There are many similar types of compression algorithms in use or otherwise available to the inventor for compressing data. Current compression algorithms are typically static and compress all of the data regardless of the relative importance of the data.

Therefore, what is clearly needed is a self-powered monitoring device having compression modalities and utility modalities that might be manipulated to reduce energy requirements for data transmission and that are adaptive to compress data based on data context.

### BRIEF SUMMARY OF THE INVENTION

In an embodiment of the invention a device is provided comprising a processor, a memory system coupled to the processor, an on-board, rechargeable power supply, one or more data-capture mechanisms, circuitry enabling wireless data transmission on a network, rules and criteria stored in the memory system regarding characteristics of data, and coded instructions executing on the processor from a non-transitory physical medium, providing a process wherein data captured by the one or more data-capture mechanisms is examined applying the rules and criteria regarding characteristics of data, and data is transmitted via the network by specific processes selected depending on the characteristics, the specific data transmission processes enabled to minimize power consumption from the on-board power supply.

In one embodiment of the device the examination results in portions of data indicated as having different levels of importance. Also in one embodiment alternative modes of data compression are selectable, different modes having different power-consumption characteristics, and wherein data indicated as having lesser importance is either discarded or transmitted by one or more data transmission processes with a low power consumption characteristic. Also in one embodiment one or more of resolution, color depth, and frame rate are altered to reduce power consumption for data of low importance. Still in one embodiment circumstances of data capture are considered in examination of captured data as well as characteristics of the captured data, and specific data transmission processes are selected depending on the circumstances of data capture.

In one embodiment of the device the circumstances of data capture comprise specific time or duration of data capture. Also in one embodiment the one or more data capture mechanisms comprise a video camera, and level of importance of data is determined by specific image characteristics in different portions of a video frame. Also in one embodiment the device further comprises circuitry for two-way communication with remote nodes on the network, and execution of the coded instructions seeks presence of a listener for data at a remote node addressed for data transmission, and circumstances of transmission are determined according to the presence or absence of a listener.

In one embodiment the device further comprises circuitry for two-way communication with remote nodes on the network, and instructions received from a remote node on the network are followed in selecting circumstances of data transmission. And in one embodiment the specific data transmission processes include altering frequency and/or duration of transmission.

In another aspect of the invention a method is provided, comprising capturing data by one or more data-capture mechanisms coupled to a device having a processor, a memory system coupled to the processor, an on-board, rechargeable power supply, circuitry enabling wireless data transmission on a network, rules and criteria stored in the memory system regarding characteristics of data, and coded instructions executing on the processor from a non-transitory physical medium, examining the captured data applying the rules and criteria regarding characteristics of data, and transmitting data via the network by specific processes selected depending on the characteristics, the specific data transmission processes enabled to minimize power consumption from the on-board power supply.

In one embodiment of the method the examination results in portions of data indicated as having different levels of importance. Also in one embodiment alternative modes of data compression are selectable, different modes having different power-consumption characteristics, and wherein data indicated as having lesser importance is either discarded or transmitted by one or more data transmission processes with a low power consumption characteristic. Also in one embodiment one or more of resolution, color depth, and frame rate are altered to reduce power consumption for data of low importance. Also in one embodiment circumstances of data capture are considered in examination of captured data as well as characteristics of the captured data, and specific data transmission processes are selected depending on the circumstances of data capture.

In one embodiment of the method the circumstances of data capture comprise specific time or duration of data capture. Also in one embodiment the one or more data capture mechanisms comprise a video camera, and level of importance of data is determined by specific image characteristics in different portions of a video frame.

In one embodiment the method further comprises circuitry for two-way communication with remote nodes on the network, and execution of the coded instructions seeks presence of a listener for data at a remote node addressed for data transmission, and circumstances of transmission are determined according to the presence or absence of a listener. Also in one embodiment the method further comprises circuitry for two-way communication with remote nodes on the network, and instructions received from a remote node on the network are followed in selecting circumstances of data transmission. And in one embodiment the specific data transmission processes include altering frequency and/or duration of transmission.

### BRIEF DESCRIPTION OF THE SEVERAL VIEWS OF THE DRAWINGS

FIG. 1 is a block diagram of components within a self powered device (SPD) according to an embodiment of the present invention.

FIG. 2 is an architectural overview of a communications network of SPDs connected to a larger wide area network (WAN) according to an embodiment of the present invention.

FIG. 3 is a sequence diagram depicting communication between SPDs and a monitoring terminal.

FIG. 4 is a sequence diagram depicting communication between SPDs and a monitoring terminal through a communications hub.

FIG. 5 is a sequence diagram depicting communication between SPDs and a monitoring terminal through a communications hub and a network cloud server.

FIG. 6 is a sequence diagram depicting communication between SPDs and a monitoring device through a network cloud server.

FIG. 7 is a sequence diagram depicting communication between SPDs and a monitoring device through other SPDs.

FIG. 8 is a process flow chart depicting steps for dynamic compression and conversion of sensor data on an SPD for communication using less energy.

FIG. 9 is a block diagram of an SPD handling a communications event according to a control signal.

FIG. 10 is a process flow chart depicting steps for dynamic adjustment of SPD component utility settings according to an embodiment of the present invention.

FIG. 11 is a block diagram depicting dynamic selection and enhancement of an active sensor feed at an SPD among multiple sensor feeds monitored.

FIG. 12 is a process flow chart depicting steps for dynamic isolation of important sensor data among multiple incoming sensor feeds and enhancing that feed in communication.

FIG. 13 is a process flow chart depicting steps for transmitting from an SPD important sensor data according to estimated local unit cost of transmission of the data.

FIG. 14 is a process flow chart depicting steps for managing operation of on-board components of an SPD according to an embodiment of the present invention.

FIG. 15 is a process flow chart depicting steps for determining a type of compression for a video feed at an SPD based on importance of data.

FIG. 16 is a process flow chart depicting steps for dynamic determination of a most important video feed from multiple feeds and enhancing that feed while preserving low enhancement for non-important feeds.

FIG. 17 is a process flow chart depicting steps for dynamic determination of high or low quality data compression on an SPD based on important data from the feed.

FIG. 18 is a process flow chart depicting steps for dynamic determination of a transform method followed by quantization of sensor data from one or more sensor feeds at an SPD based on data importance.

FIG. 19 is a process flow chart depicting steps for dynamic determination of compression of an audio feed at an SPD based on silent portions of the feed and whether there is an active consumer of the feed.

FIG. 20 is a block diagram depicting on-board determination and isolation of motion in a video feed at an SPD.

FIG. 21 is a process flow chart depicting steps for dynamic determination of resolution, frame rate, color depth, and compression quality at an SPD based on detecting motion in a video feed above a threshold set for that sensor.

FIG. 22 is a block diagram depicting a complex of buildings monitored using multiple SPDs communicating through a communications Hub to an off or on site monitoring terminal.

FIG. 23 is a block diagram depicting steps for dynamic determination of an active video feed among multiple SPD feeds and isolating and displaying the feed at high resolution, frame rate, and color depth.

FIG. 24 is a block diagram depicting isolated coverage of regions of an overall videoed area for post video assignment of resolution, frame rate, color depth, and compression quality at an SPD before communication.

FIG. 25 is a block diagram depicting isolated coverage of regions of an overall videoed area for post assignment of resolution, frame rate, color depth, and compression quality on an SPD before communication.

FIG. 26 is a process flow chart depicting steps for generating a communication event from an SPD based on multiple detected criteria according to an embodiment of the present invention.

### DETAILED DESCRIPTION OF THE INVENTION

In various embodiments described in enabling detail below the inventor describes a unique system including at least one self-powered device and methods for reducing energy required to communicate collected data from the self-powered device to any monitoring device. The present invention is described using the following examples, which may describe more than one embodiment falling within the scope of the invention.

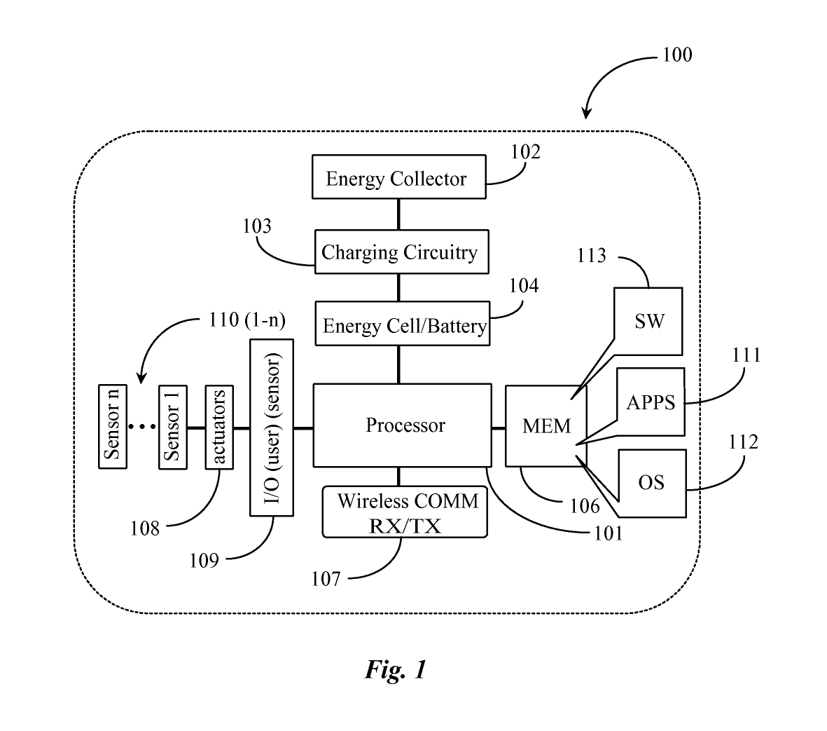

FIG. 1 is a block diagram of components within a self powered device (SPD) 100 according to an embodiment of the present invention. SPD 100 is a self-powered data collection and communication apparatus or device, meaning that it has its own power supply and can be remotely placed in a network of such devices. SPD 100 collects data by means of on-board or peripherally connected sensors 110 (1-n), or a combination of the above. SPD 100 is a computerized device and includes a processor 101 for processing data and executing coded instructions (SW). Processor 101 has access to memory (MEM) 106 for storing an operating system 112, applications 111, and software (SW) 113 aiding in operations relative to functionality in embodiments of the invention.

SPD 100 is a communication device and includes a wireless communications module 107 including receiver (RX) and transmission (TX) capability enabling SPD 100 to communicate wirelessly with other devices. Wireless component 107 may operate in various protocols, such as wireless USB, Bluetooth™, near field communication (NFC), wireless fidelity (WiFi), wireless local loop (WLL) telephony, and other known protocols. SPD 100 in this embodiment includes an energy collector 102 for generating power for use or for storage on the device. Energy collector 102 may be a voltaic or photocell, a solar cell or panel, an electromagnetic generator, or any other type of electricity generator. The energy collector is not required to practice the invention.

SPD 100 includes one or more energy cells or batteries 104 for storing collected energy. In a preferred embodiment energy cell or battery 104 is rechargeable using energy collector 102 and or a conventional AC charger that might be plugged into the device. SPD 100 includes a power converter 105 for converting energy collected by energy collector 102 to a form suitable for storage and eventual consumption by the device. In some implementations element 104 may not be a battery or other electrical storage element, but a mechanical subsystem for storing energy, such as by spring compression or compressed gas. In such cases a power converter is necessary to convert the potential energy of the mechanical storage element to electrical energy, which may be stored in a battery or used directly to power elements of the device.

The power converter may include a mechanism to convert the collected energy to a suitable form to be stored in an energy storage device or system. Examples may include a direct DC to DC power supply that would convert a low voltage current from photovoltaic collector to a higher voltage to charge a battery. Another example may be an AC to DC power supply that would convert a low voltage current from inductive field based collector to a higher voltage to charge the battery. In one embodiment, SPD 100 includes input/output user controls 109 for configuring or adjusting sensor parameters. In some cases user input may be treated as sensor input. SPD 100 may also include one or more actuators 108 for controlling sensor operations or operations of other on-board devices that may have moving parts, for example, energy collector 102. Moving parts may include positional apparatus for positioning an energy collector for optimum energy collection and so on. Another moving part that might be controlled by an actuator may include a shutter over a video camera or still camera. Sensors 110 (1) through (n) may be a combination of on-device and remote sensors. An SPD in different embodiments may contain or include or control one or more than one sensor. A sensor 110 (1-n) may include a camera that records audio/video/or still photos including color black and white infrared, etc.

A sensor may include a dedicated sound recorder or device. Sensors of any type may be included in embodiments without departing from the spirit and scope of the invention, as there are many different applications possible where the SPD of the invention might be deployed. For example, one application may be a security application where detection and communication of motion, audio and video presence is important. Another application may be in medical patient monitoring where sensors may be attached to a patient and may detect certain medical events or states and communicate those states as data. Still another application may be an environmental application where gases, chemicals, heat, earth movement, or other environmental states or conditions might be detected and communicated.

SPD 100 executing coded instructions 113 may analyze sensor data for importance of the data (data context) and may alter or modify the data for communication over a wireless connection to another (monitoring) device connected to the network. Modification of the data may optimize compression of the data for transmission, including dynamic selection (on the device) of a single or combination of compression modalities provided to (loaded on) the device in the form of software or firmware.

Applications 111 may include third party or first party applications adapted for the field of use of the SPD upon which they are loaded. For example, if the use case is a medical monitoring network, the application may be a medical application for operating the sensors and providing instruction covering operation in all available modes of the device and of the device's sensors. If the use case is security, then application 111 might be adapted for detecting security breaches with the aid of the sensors including cameras, if the security system includes optical or video monitoring. A security system may also be trip or trigger-based such as breaching of a secure entry setting of a sensor connected to a compromised entry.

SPD 100 may be an existing appliance that may be adapted by SW 113 to practice the invention. For example, SPD 100 may be a third-party appliance such as a video phone, a cellular telephone, a notebook computing device or other wireless appliance capable of supporting the sensors and of communicating the sensor data over the wireless network. In one embodiment SPD 100 is a dedicated device that is specifically adapted for use according to a field of application, whether security, medical, environmental, or other application. An SPD may include more or fewer components that those depicted without departing from the spirit and scope of the present invention.

Minimally, an SPD may comprise only the previously mentioned components responsible for processing sensor data and communicating the processed information over a wireless connection to other devices or systems in one of more than one power saving mode or operation. The SPD in a minimum configuration also includes the power source for the operation on the device and for powering one or more sensors, and a memory for storing application data, SW instructions, and temporary information generated during processing.

It is not required that an SPD include an energy collector or charging system, or any actuators in order to practice the present invention. The addition of certain components such as an energy collector may simply aid in conserving energy otherwise used in processing and communication of data to other nodes on a network. Most of the energy loss for a device like SPD 100 comes from communicating the information collected by the sensor apparatus, including a video/image/audio recorder. Therefore, the invention pertains more to managing the energy drain dynamically to conserve more energy while the device is operating and communicating to save power on the device.

Objects of the invention may be accomplished using a variety of methods either singularly or in combination. The energy required for communication is at least partly dependent on the amount of data that must be transmitted over a specific communication system and a bit error rate. If the amount of data transmitted can be reduced, the energy required to transmit that data will reduced proportionately. Although the reduction of energy required can be thought of as a reduction of the length of time that is required for the communication at a constant power level, in practice it may also be achieved by one or a combination of other methods, for example by proportionately reducing the power level and sending the data at a lower rate for the same time period as would have been required by the original data.

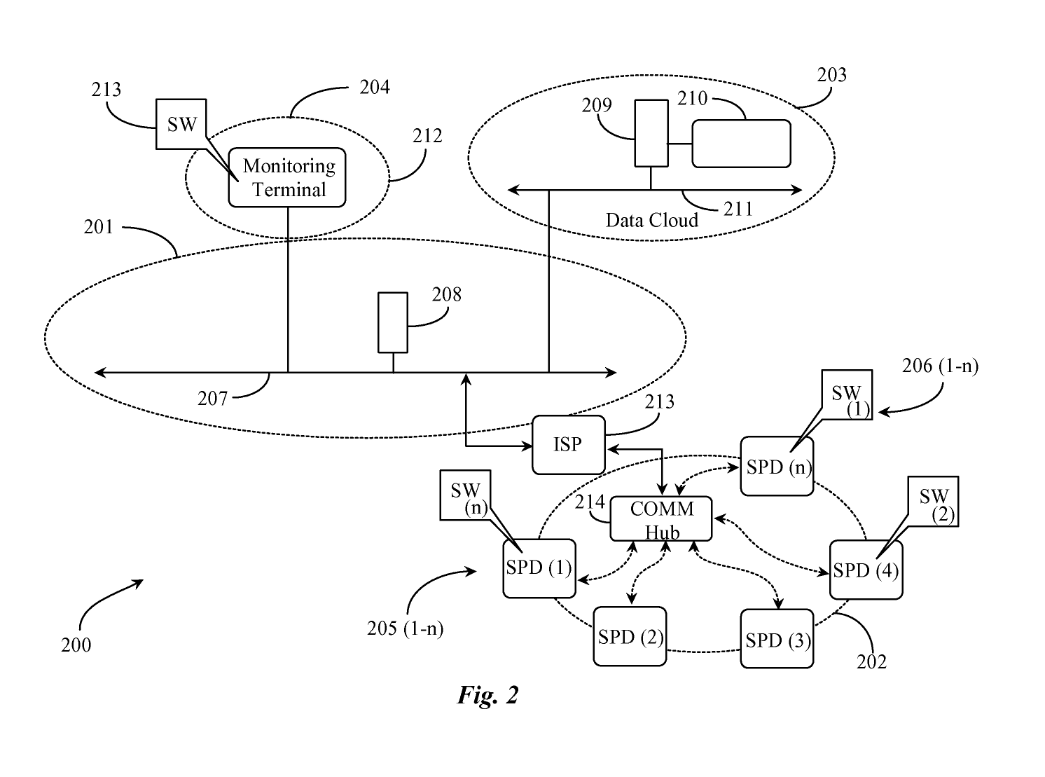

FIG. 2 is an architectural overview of a communications network 200 comprising SPDs 205 (1-n) connected to a larger wide area network (WAN) 200 according to an embodiment of the present invention. WAN 200 may be Internet network 201 represented in FIG. 2 by a network backbone 207. Network backbone 207 may represent all of the lines equipment and access points that make up the Internet network as a whole. Therefore, there are no geographic limitations to the practice of the present invention. Network 201 may also be a corporate WAN or a local area network (LAN) such as a local Ethernet network without departing from the spirit and scope of the invention. In one embodiment, network 201 may be a transaction data network wherein certain data collected may be used to enact, initiate, close, or otherwise conduct a transaction or a transaction procedure.

In the example of FIG. 2 network backbone 207 may be accessed via a communications carrier network (not specifically depicted but assumed present) having a connected Internet service provider 213 accessible therefrom. A network of SPDs 205 (1-n) is depicted in this embodiment. SPDs 205 (1-n) are connected in this example to a communications hub or router 214 on a local wireless network 202. Wireless network 202 may be a wireless LAN, a WiFi network, a wireless local loop (WLL) telephony network, or another wireless network with a range sufficient to communicate with all of SPDs (1-n) through communications hub or router 214.

Communications hub 213 provides the wireless signal for SPDs 206 (1-n) and has connection to an Internet Service Provider (ISP) 213 in a wireless carrier network such as a 4G cellular telephony carrier network for example. In some implementations the SPDs may directly connect to a wireless network without the hub. SPDs 205 (1-n) each may include SW instances 206 (1-n) installed locally to provide local operating instructions including dynamic selection of one or a combination of available compression modalities for compressing any data that may be communicated from the SPD to another node on the network.

In this example, network 202 may be a security network of video cameras that communicate video data to one or more than one other remote network terminal such as a monitoring terminal or terminals 212 at a remote location 204, which might be a service location, a user location, or a mobile location where the user is using a mobile terminal. In this case communication is routed through communications hub 214 and ISP 213.

Monitoring terminal 212 may be a general purpose computing appliance such as a desktop or laptop computer connected to the Internet network 201. Terminal 212 may have SW 213 resident and executable for interaction with SPDs 205 (1-n) aided in this embodiment by SW instances 206 (1-n). In one embodiment the monitoring terminal may be an android device, a cellular telephone, a notebook, or any other communication appliance or device that has an operating system and a processor and a mechanism for user input.

Network backbone 207 supports a network server 208 which may host a website (not depicted) through which users may register for a third-party service that enables users to set up their own SPD networks and monitor SPD feeds or communicated data remotely from any Internet-connected device or appliance hosting SW 213. In this embodiment an operator may communicate with his or her SPD network from anywhere that has access to the Internet. It is important to note herein that monitoring terminal 212 may be a dedicated terminal or a general purpose machine or device without departing from the spirit and scope of the present invention.

Network backbone 207 supports a cloud-computing network (data cloud) 203. Data cloud 203 includes a cloud data base 210 connected to a cloud server 209. Server 209 may process data communicated thereto from SPD network 202 via the network and may push results or notification of results of processing to terminal 212 running SW 213. In some embodiments cloud processing services may be used and in other embodiments they may not be required.

To illustrate an example where cloud computing may be used, consider SPDs 205 (1-n) to be wireless musical instruments streaming audio data through communications hub 214 to cloud server 209 for audio processing after which terminal 212 may have access to the results of the processing. Many other use applications may also apply where cloud computing may be integrated into the process as part of a third party service without departing from the spirit and scope of the present invention.

In this architectural depiction a monitoring user may generally monitor network 202 from a remote location or from the same location as the SPD network. Network 202 may be a smart home network where SPDs 205 (1-n) report sensor data relative to common or uncommon utilities like a sprinkler or watering system, a heating and air system, a solar powered pool, etc. In such a case the data may be reported to an owner's monitoring terminal or device like terminal 212 at location 204.

SPDs 205 (1-n) expend most of their stored energy communicating or reporting data. The present invention in one embodiment provides at least one energy-saving function locally at individual ones of the devices by means of provision of multiple data compression modalities and instruction for selecting specific ones or a combination of those compression modalities to compress the data collected for transmission over the wireless network, the selection depending on preprogrammed rules. The energy saved is the energy stored on the device battery or energy cell. It is also noted herein that an SPD may in operation, in one embodiment, rely partially on stored energy and partially on energy collected by an energy collector provided to the device such as a solar cell.

Dynamic selection of compression modalities for data or combinations thereof is just one way that SPDs conserve energy according to an embodiment of the present invention. Other energy saving procedures may be practiced by the SPDs with the aid of SW 206 (1-n), such as reducing frequency of communication events transmitted from the devices. Still other methods for conserving device energy may include purging or ignoring redundant data or data that is not determined to be important to communicate, and consulting presence information, such as if there is a listener for the data or a request for the data before data is communicated from the devices, or if a receiving device is brought within a specific range of the transmitter of the data and is detected by the transmitter.

In addition to the options mentioned above, certain mechanical aspects of an SPD may be controlled via one or more mechanical actuators for operating SPD features like a rotating solar collector, for example, or opening and closing a camera shutter. These functions as well as the functions of the SPD internal components may be manipulated by a user operating a general-purpose monitoring device, a dedicated monitoring device, or either type of device in a mobile wireless or wired network setting. More detail about methods for conserving energy in data transmission from an SPD is provided later in this specification.

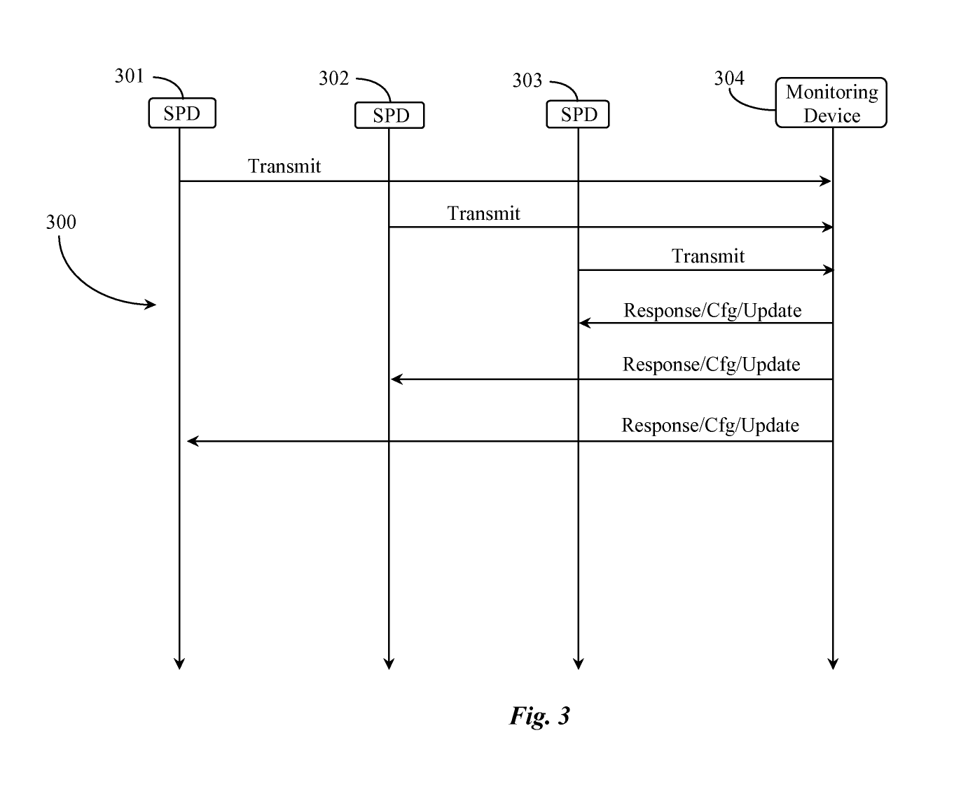

FIG. 3 is a sequence diagram 300 depicting communication between SPDs and a monitoring terminal. In this example an SPD 301, an SPD 302, and an SPD 303 communicate directly with a monitoring terminal (device) 304. Monitoring device 304 may be a wireless notebook, cell phone, android device, etc. In one embodiment the monitoring device may be booted up by detecting the active SPDs wirelessly and may establish communications paths directly to those SPDs. If a new SPD becomes active during operations the monitoring device may detect and automatically establish a wireless channel to the new device. Each SPD may have a separate machine address on the network. In one embodiment the wireless protocol is Bluetooth™, in another embodiment it may be wireless LAN protocol, wireless universal serial bus (WUSB).

In a simple example of this sequence scenario, consider that SPDs 301-303 are medical sensor devices that are connected to a patient in some manner and that monitoring device 304 is the patient's smart phone or a smart device operated by a caretaker of the patient. If sensor data becomes available at SPD 301, device 301 may compress that data according to energy saving instruction and may communicate the data directly to monitoring device 304. The same is true for SPDs 302 and 303. The operator may user the monitoring device to directly respond, configure, and/or update the communicating SPDs.

In this very simple example an SPD may simply be a medical sensor device with capability of compressing collected sensor data according to an energy-saving strategy implemented in instruction on the device. SPDs may also have energy saving features that might be dynamically selected or programmed to occur conditionally or with limitations or constrains by SW instruction on the device.

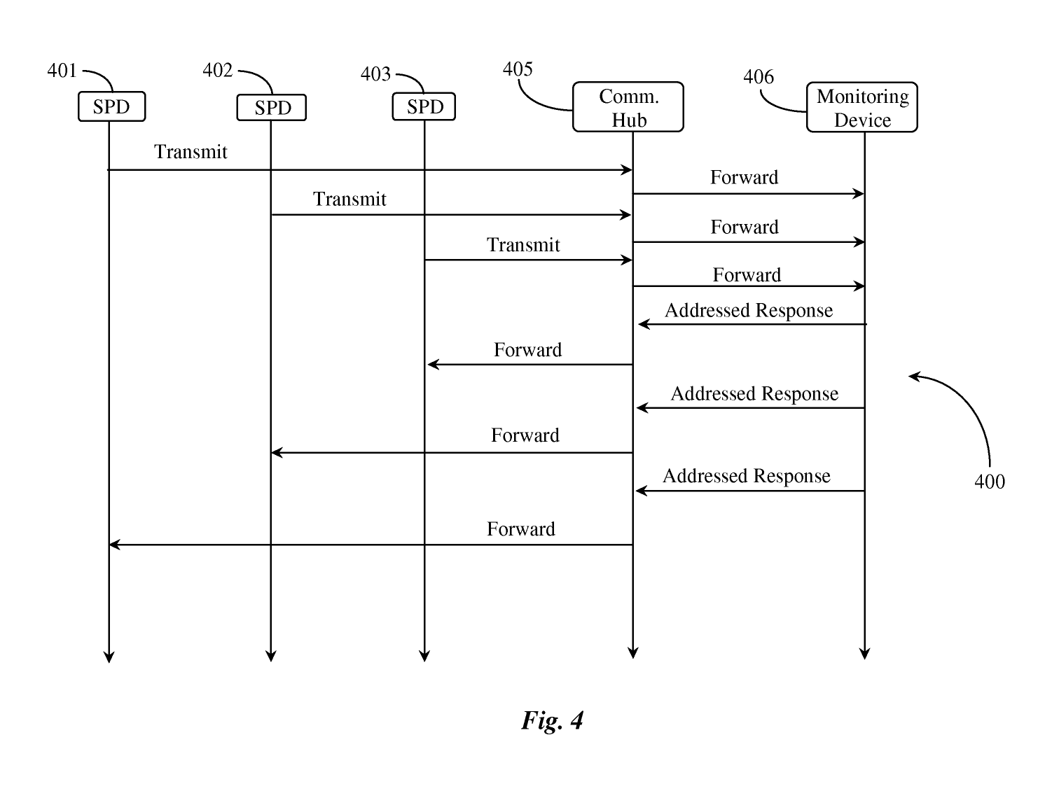

FIG. 4 is a sequence diagram 400 depicting communication between SPDs and a monitoring terminal through a communications hub. In one embodiment of the present invention SPDs may communicate with a monitoring device through a communications hub or “router” common with several types of wireless networks. This example may be analogous to SPD network 202 of FIG. 2 where the monitoring terminal is on site and communicates with the SPDs through the communications hub 214.

In this example SPDs 401, 402, and 403 transmit sensor data collected to a communications hub 405. SW on the SPDs includes instruction for selecting a compression mode from a pool of compression modalities that best suits the communication event in terms of priority or importance of the sensor data collected, whether there are listeners or requesting parties waiting for or expecting the data for transmission, and load effect on the power state of the particular SPD sending the data.

Communication hub 405 forwards communication events transmitted from SPDs 401-403 on to the correct monitoring device or terminal 406. Monitoring terminal or device 406 may or may not respond to SPD communication events it receives. If a response communication or at least an acknowledgment of receipt of data from an SPD may be routed through communications hub 405 and to each SPD. Responses may be addressed uniquely to each receiving SPD. In one embodiment a user operating a monitoring terminal such as terminal 406 may send manual control signals or messages to one or more of SPDs 401-403 that may help direct the particular SPDs what context might be considered critically important, moderately important, and not important, giving the SPD the task of determining if the current context should be communicated or not and if communicated what compression modality might be used in light of context importance.

In one embodiment functions of the invention may be integrated into a smart office or smart home network (SOHO) for controlling heating and air, computing bandwidth, entertainment systems, watering systems, or any other system that may be computer controlled and where sensor data, including time-based sensors or event sensors might trigger communication and adjustment of settings.

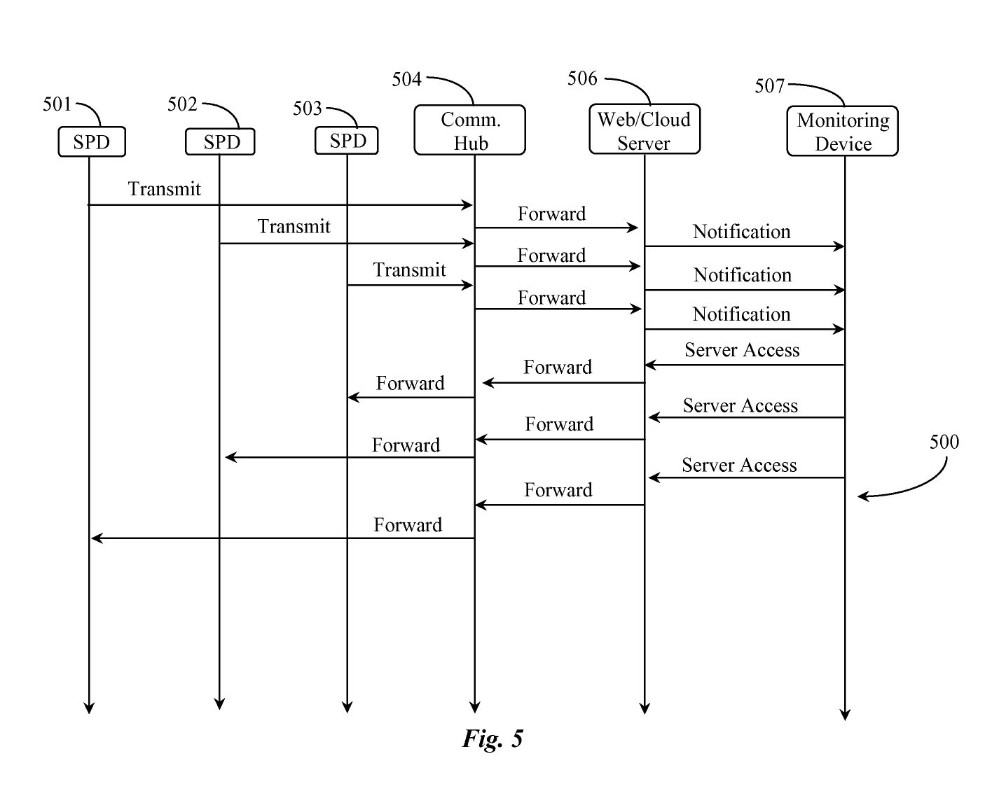

FIG. 5 is a sequence diagram 500 depicting communication between SPDs and a monitoring terminal through a communications hub and a network cloud server. In this example a web and or cloud data processing server 506 is introduced in the routing sequence. In this case SPDs 501, 502, and 503 have communication routed through a communications hub 504 similar to the example of FIG. 4. Communications hub 504 has access by way of network connection to web/cloud server 506. Network connection may be through a communications carrier network and an ISP as depicted further above in FIG. 2. In one embodiment a web server executing a web site may function as a proxy server in communication with a cloud server.

In this example communications hub 504 forwards or routes all communication events from SPDs 501, 502, and 503 to server 506 through an ISP and various nodes or routers between the hub access point on the larger network and the cloud server. The cloud server may process data sent from SPDs and some determinations may be made dynamically according to rules about data, such as screen communication events at a higher priority level for example. In this embodiment SPDs function to dynamically compress data for transmission and may be controlled to some extent by external signals or messages that provide current priority or preferences in specific sensor data context that should be packaged as a communications event and transmitted wirelessly to communications hub 504.

In this embodiment a monitoring terminal or device 507 may be located remotely from the SPD location and may be a fixed or mobile terminal connected to the larger network. Monitoring device 507 may receive notifications from server 506 of pending communication events at the server. In each notification instance an operator at the terminal may select the notification and access server data summarizing or detailing the state data transmitted by the SPD. In the case of server access the monitoring device operator may, while connected to the server, select and view data such as text readings alert information, streaming video, audio, video/audio, or still camera feeds using the devices input methods and display screen to view the information.

In one embodiment the sensor data transmitted is streamed in near real time to the monitoring terminal from the cloud server in a push model. In such a case it may be determined by presence data whether there is an operator at a monitoring terminal ready to receive data from a sensor. In one embodiment a terminal operator may boot SPDs remotely activating them to report information. In one embodiment there may be more than one monitoring terminal assigned to receive SPD information from a group of SPDs. Each SPD may include the address information of one or more external nodes that it must communicate with or route data through. In another embodiment the end destination point might be dynamically switched according to criteria such as the context of the sensor data received and processed at a processing point such as a cloud server or monitoring station or machine.

Server 506 may forward information in response to communications hub 504, which in turn forwards the responses to the appropriate devices. A possible response from a monitoring terminal may be to shut down or enter a sleep cycle. A monitoring terminal may be equipped to send a variety of control signals or machine-readable coded messages to SPDs in order to remotely control or operate and or update the SPDs.

It is not required that a monitoring server respond to an SPD sending data. For example, multiple SPDs may be sending video data simultaneously to a single monitoring terminal that may be visually displaying each feed as a thumbnail, and one or more important feeds in larger viewing windows on the same screen. An operator selecting a formerly reduced thumbnail video feed from an SPD may generate a remote control signal to that particular SPD that is now being prioritized in view at the monitor. This signal may trigger a preset mode at the SPD to switch to the highest resolution, color depth, frame rate, and compression quality for the time that the user retains the view on the monitor screen.

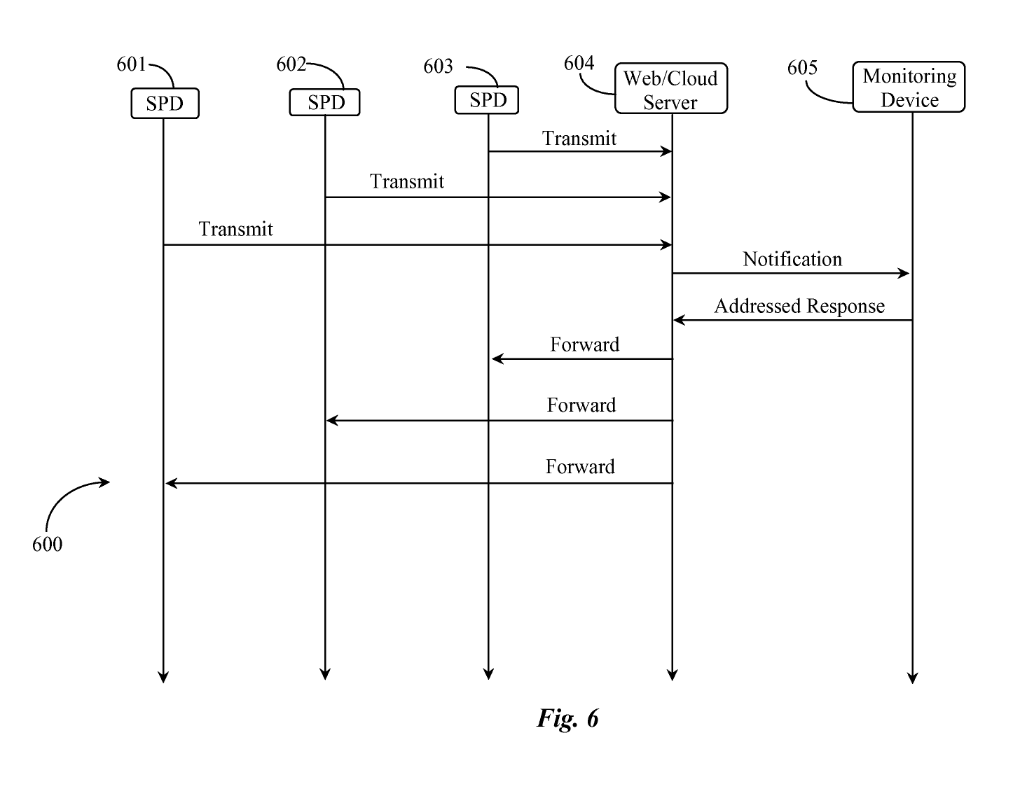

FIG. 6 is a sequence diagram 600 depicting communication between SPDs and a monitoring device through a network cloud server. In another sequence variance, SPDs in this example are not wirelessly tethered to a hub and may not be geographically associated together or be situated within wireless range of one another. SPDs 601, 602, and 603 may be wirelessly operated communications devices like a general purpose smart phone adapted by software and one or more sensor capabilities to function as an SPD for a determined time period or as needed.

In this embodiment phones (SPDs) 601, 602, and 603 are network-capable appliances, meaning that they may connect onto an Internet network or larger WAN and connect directly to a web or cloud data server 604 analogous to server 506 described further above. In this case each SPD is somewhat autonomous but may be grouped by service association such as an environmental service or study using regionally distributed representatives operating smart phones or android devices modified by instruction and sensor capability including peripheral sensors and sensor cables to collect environmental data in those specific regions or areas. Energy saving decisions made on those smart phone devices with respect to the energy required to transmit the collected sensor data to a first demarcation point on the larger network may save money (conserved energy/network transmission or bandwidth charges) for a hosting entity or entity responsible for providing the service or conducting research.

Server 604 may receive data from connected SPDs 601, 602, and 603 including full multimedia such as streaming video data/video/audio data, etc. In a variation of this embodiment where SPDs may be manned smart phones, data sent to server 604 might include operator input such as voice comments, text inserts, additional images, or other media. User input may be combined with sensor readings such as user augmentation of sensor data with additional information that may be relevant to readings in one or a series of communication events.

In one aspect, server 604 may combine all current data streams or data incoming from SPDs 601-603 and forward it or send notification to access to monitoring device 605. Monitoring device 605 may be a general-purpose computing device adapted by SW to receive and display data received from server 604. In one embodiment monitoring device 605 may be a mobile smart phone and also adapted to function in an SPD “mode”. Monitoring device 605 may communicate wirelessly to a first demarcation point of connection to the network through an ISP like SPDs 601 through 604. Monitoring device may also be fixed and wired to the network without departing from the spirit and scope of the present invention.

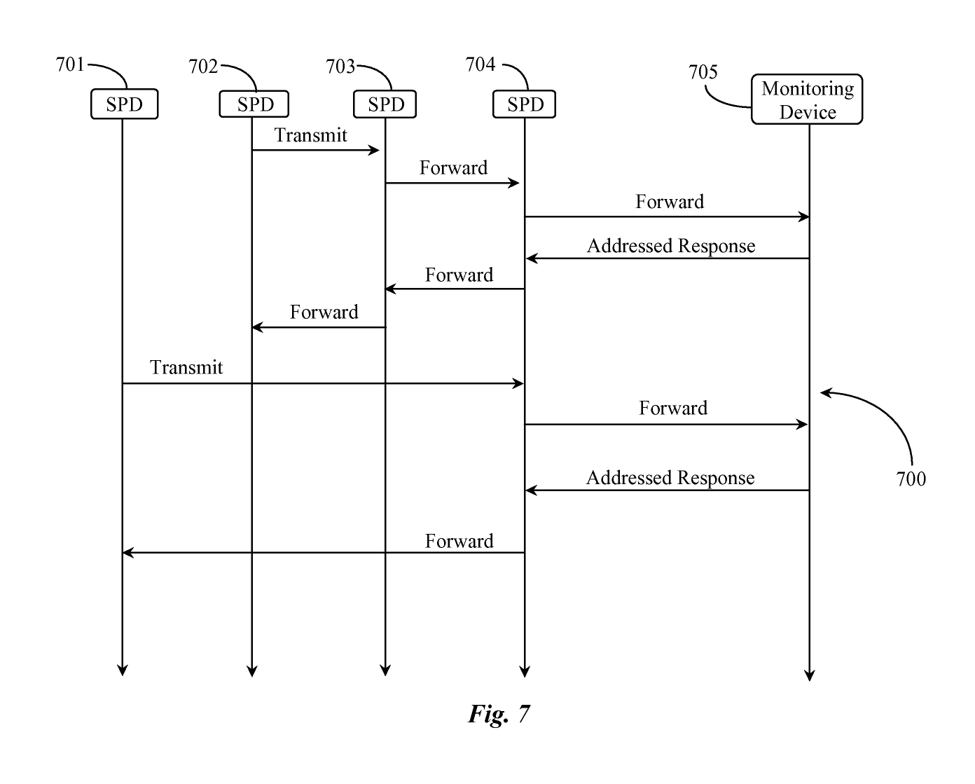

FIG. 7 is a sequence diagram 700 depicting communication between SPDs and a monitoring device through other SPDs. In this variation of sequence of interaction between components, SPDs are assigned to use other nearby SPDs within wireless range as routes to further reduce or “share” energy costs of transmitting data to the monitoring device.

In this example SPD 701 may communicate collected sensor data to SPD 704 and then to monitoring device 705. SPD 702 may transmit collected sensor data to SPD 703, which in turn may route the received data through SPD 704 nearest the monitoring device. This type of relay routing may conserve energy in a wireless network by reducing the distance between the sending and receiving nodes. This embodiment may also be practiced with a communications hub being the final hop before the monitoring device. In one embodiment transmission distance and/or interference from other communications or noise may be factored into the adaptive compression modes algorithm as higher energy is needed to overcome distance and interference.

SPD 704 is the last hop between other SPDs and the monitoring device 705 and the first hop between the monitoring device and the furthest SPD away from the monitor with respect to wireless range. Monitoring device 705 may respond to SPDs by addressed response signals or codes to SPD 704 and on to appropriate SPDs down the line. In this example, each SPD receives a response control signal or code message by the same route and nodes along the route. The strategy may be specifically set to reduce distance of communication between devices.

This example is closer to the example of FIG. 3 where the architecture does not include a communications hub or server connected to a larger network. Therefore, SPDs in this example may be stationed or relatively fixed at their locations. Monitoring device 705 may also be in a relatively fixed location within wireless communication range of the SPDs. In one embodiment monitoring device 705 is mobile and optimal routing arrangements may be dynamically altered depending on where in the wireless coverage area the monitoring device happens to be.

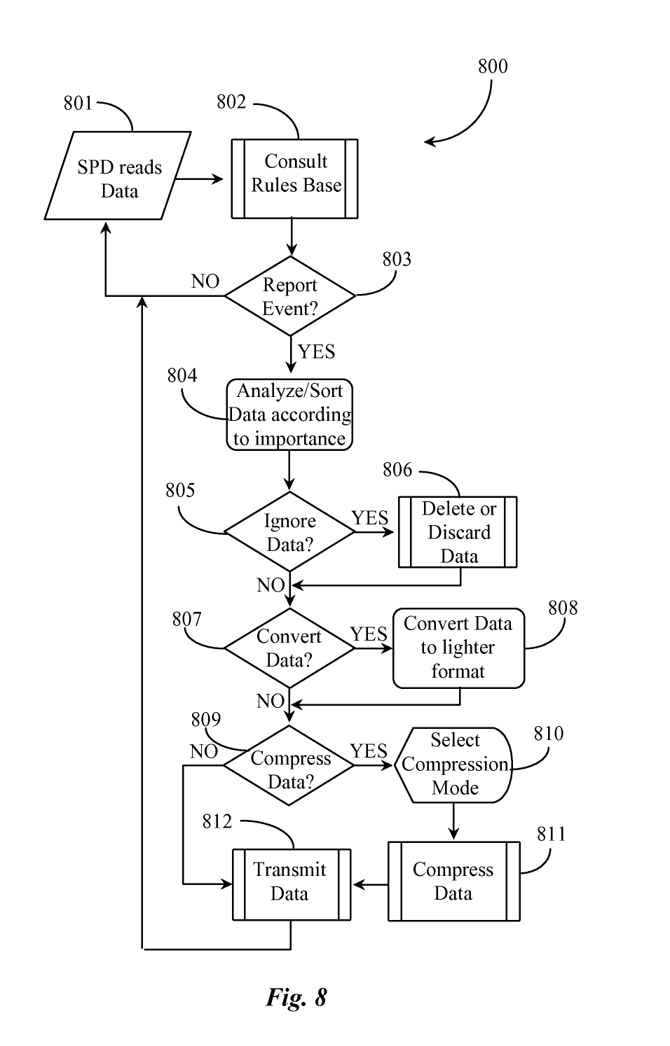

FIG. 8 is a process flow chart 800 depicting steps for dynamic compression and conversion of sensor data on an SPD for communication using less energy. In step 801 an SPD alone or within a network of devices reads incoming data from one or more than one sensor. The sensor or sensors may be one or a combination of on-board sensors or externally-connected sensors without departing from the spirit and scope of the invention. At step 802 the SPD may consult a rules base loaded on the device for treatment instructions for the type of data being parsed. Rules may include constraints or limitations, if/or clauses written in computing language or markup discernible by the application running on the device.

At step 803 a determination may be made on the SPD whether to report an event or not to report the event based on the initial consultation at step 802. If a determination is made not to report the event at step 803, the process may loop back to step 801 where more sensor data may be parsed for information. In this embodiment, the initial screening of sensor data may be preloaded or cached information on the SPD that may be updated periodically or as otherwise directed. When sensor data is available the machine may parse the data according to rules about what data is in a category for reporting and what data may not be. Data may be screened for information that reveals, after initial consultation with the rules base, whether it is the type of data to report without yet addressing priority level of the data.

If at step 803 a determination is made to report the collected sensor data, the SPD aided by SW may analyze and sort the sensor data at step 804 according to importance. Importance of the data speaks to context of the data or to what level of importance certain data contexts may have to a listener or monitoring entity requiring the data to make important decisions. It is important to note herein that importance criteria for certain data contexts may change dynamically or by learned behavior on the SPD.

At step 805 a determination may be made whether to ignore some or all of the collected sensor data. In this step all of the sensor data or some of the sensor data may be deleted at step 806 if at step 805 the determination is to ignore or delete data. The determination is made based on the results of step 804. A threshold for discarding data from collected sensor data may relate to criteria such as what data may be redundant data of repeated more than required. Another threshold might be data that is more critical to view than other data in a video feed for example. Therefore, it is highly likely that at least some of the sensor data collected and analyzed at step 804 will be communicated.

At step 807 a determination may be made whether to convert data from one format to another format for transmission over the wireless link. If it is determined to convert data formats at step 807 from one format to another the SPD aided by SW may convert the data to a lighter format requiring less bandwidth to send at step 808. Speech to text conversion may be an example. Another example might include converting from a heavy picture format to a lighter picture format for transmission using less bandwidth and therefore less energy drain on the SPD.

At step 809 a determination may be made as to whether to compress the sensor data for transmission. If at step 809 it is determined to compress data the SPD may select a compression modality from more than one available compression algorithm. Compressing data may add some energy drain to an SPD so it might be determined if the extra drain is worth the energy relative to the context of the data and how useful it may be at the receiving end. If it is determined that data be compressed at step 809 then a compression mode may be selected in step 810 to compress the data. In one embodiment any device receiving compressed data from an SPD has the same compression and decompression modalities available locally so all compressed data is recognized and may be decompressed for use on the receiving device.

In one embodiment some of the data may be compressed using one modality while other data may be compressed using a different compression algorithm. In one embodiment, low bandwidth or less important data may be compressed in low energy and low bandwidth monitoring mode. In this embodiment rich data or more important data may be compressed in a high energy and high bandwidth listening mode.

At step 811 the SPD with the aid of compression SW compresses the data for communication to another device and transmits the data in step 812. The process may then resolve back to step 801 where more sensor data may be collected. The type of compression used on data may depend partly on the type of data being compressed and how important the data may be in context to the receiving party.

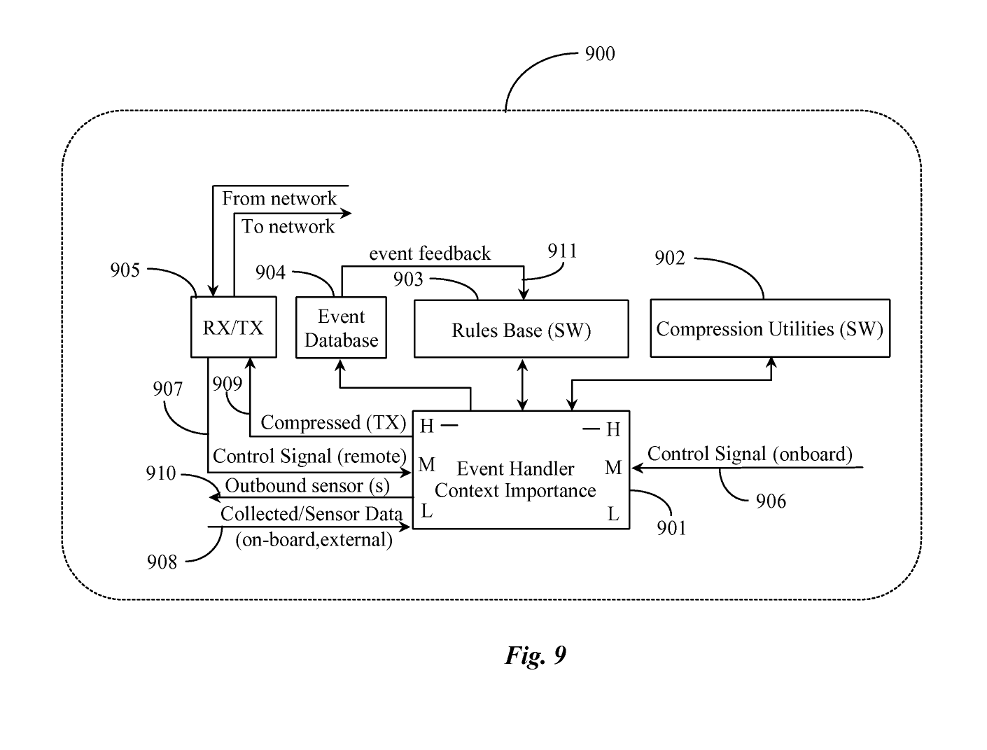

FIG. 9 is a block diagram of an SPD 900 handling a communications event according to a control signal. SPD 900 is depicted in a state of handling a communication event. Components depicted herein are components relative to determining importance level for sensor data and selecting one or more compression modalities available on the device. A communication event may be handled by an event handler 901 that is charged with screening and analyzing collected sensor data received from an external or on-board sensor over a sensor data communication channel 908. In one embodiment sensor data is wirelessly transmitted to SPD 900 through a wireless receiver/transmitter (RX/TX) 905. In one embodiment sensors are on-board the device and output collected data directly to the event handler. In one embodiment there is a wireless receiver/transmitter (RX/TX) also termed a transceiver for communicating to and from a larger network through a wireless carrier and one for communicating with local off-board or external sensors using another wireless protocol such as wireless USB.

Event handler 901 may be configured on the fly by control signal to equate a level of importance to a particular context of the sensor data. A control signal may be a signal generated on SPD 900 according to preloaded criteria accessible to the event handler in a rules base 903. For example, if consultation with rules base 903 for sensor data type for communication qualifies particular data for transmission, the event handler may receive a control signal or message indicating what contexts of sensor data are of high importance, moderate importance, or low importance. This may be performed in real time as the event handler parses sensor data to determine context or contexts of the data.

In one embodiment a control signal or message may be remotely generated and communicated to SPD 900 through RS/TX 905. In one embodiment a control signal simply identifies data context criteria of high, medium and low importance. For example, in a motion video the face and upper body area of a person on camera may be considered of higher importance than the person's lower extremities. In another application the context may be different and may have to be updated on the device if not communicated to the device when the device is sensing data. Event handler 901 may according to context importance to the receiving party select the most economical compression utility (SW) available in memory 902. Event handler 901 may create a transmission of compressed data addressed to one or more network connected devices or nodes.

In one embodiment a record of a transmission of data (communication event) may be copied or otherwise recorded into an event cache or database 904 in device memory. In one embodiment an event feedback loop 911 is provided from event database to rules database 903. In this way trends developing in listener or operator preferences in data context from sensors may be fed back into the system so that the system may learn which contexts in sensor data are emerging as more important data, and rules may be altered according to history. In one embodiment statistics resulting from selected compression modes for sensor data context preferences might be leveraged to teach a predictive algorithm to statistically predict a likelihood that certain sensor data contexts will appear in sensor data in light of other information such as time of day or night the sensor is more apt to sense data of particular contexts as statistically born out over past operations.

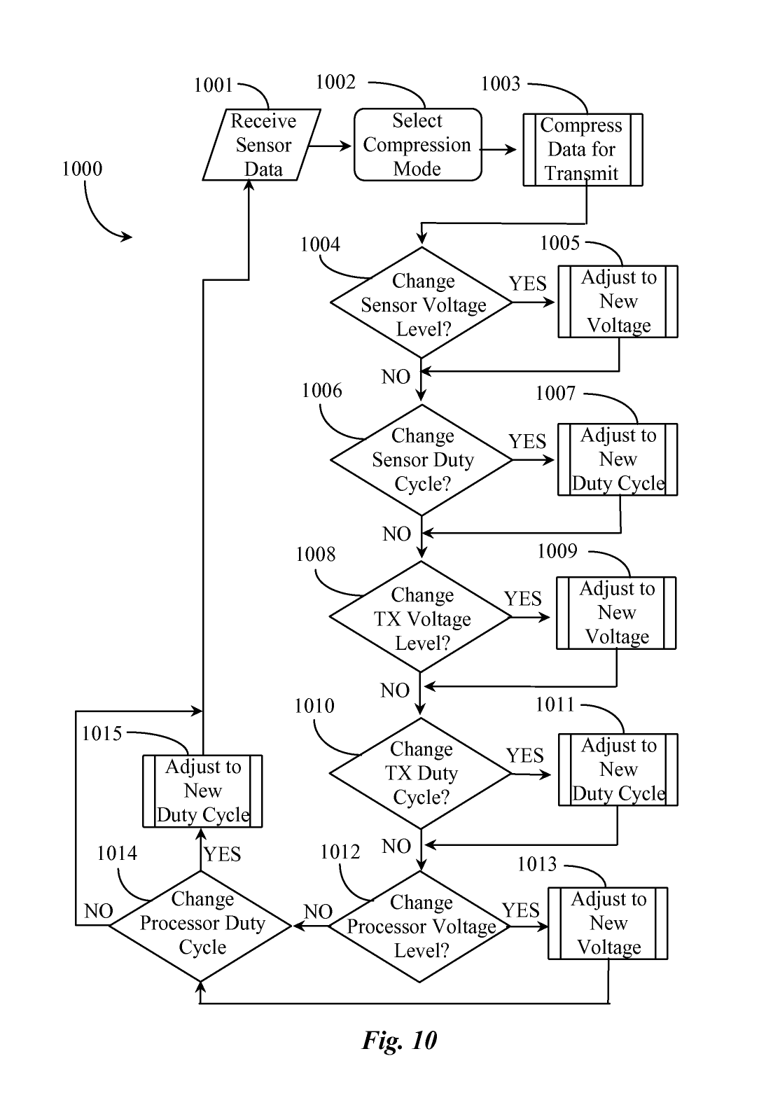

FIG. 10 is a process flow chart 1000 depicting steps for dynamic adjustment of SPD component utility settings according to an embodiment of the present invention. In step 1001 an SPD receives sensor data from an external sensor or sensor data becomes available on board the device. At step 1002 the event handling apparatus selects an appropriate compression mode for the data in transit. In this embodiment it is assumed that the processes of verifying and qualifying the sensor data for communication has been accomplished between steps 1001 and 1002.

At step 1003, the data for communication may be compressed for transmission according to current rules and criteria to save as much energy as possible during communications. The system may make fine adjustments during operation to further reduce energy costs of communicating sensor data over the wireless connection between the SPD and the receiving device or demarcation point to a larger data network carrying some or all of the communication over an Internet or WAN segment.

At step 1004 the system may determine whether or not to adjust the voltage level of one or more sensors collecting data for communication. If it is determined to adjust or change the existing voltage level of one or more sensors in step 1004, the adjustment or adjustments may be made in step 1005. At step 1006 it may be determined whether or not to adjust the current duty cycle of one or more sensors. A duty cycle may be described as a time-based cycle of operation including when a sensor begins listening for data to collect and when it will enter a sleep cycle, a low power cycle, or a higher power cycle. Other duty cycles may involve features of the sensor such as resolution for a camera, whether video will be captured in color or black and white, whether slow motion video will be recorded or not, etc. Still other duty cycles may relate to accessories adapted to a sensor such as operation of a shutter for a camera, an automatic lens cleaner, an antennae, a solar panel, or other possible components such as range finders, positional camera actuators, motion tracker actuators, and so on.

If it is determined to adjust or change sensor duty cycles at step 1006, the system may make the adjustment or adjustments at step 1007. If it is determined at step 1007 that no changes to any sensor duty cycles will be made, then the process may skip to step 1008. At step 1008 it may be determined whether or not to adjust or change power level for transmission of collected data on the SPD. Adjusting the transmission power level to a lower level may reduce energy drain in transmission. Such changes may be ordered based on results of past operation over a period of time and may be driven by statistics calculated over the period or operation. In some cases there may be exceptions depending on the critical nature of the transmitted data, or situations where high bandwidth and maximum power is desired for a certain communication event. It may also be noted that in one embodiment bandwidth options may be available to the system to select for transmitting a communication event.

If it is determined at step 1008 to adjust or change power level for transmitting a communication event, the adjustment may be carried out at step 1009. If it is determined not to adjust the power level for transmission step 1008 the process may skip to step 1010. At step 1010, it may be determined whether or not to adjust or change the duty cycle for the transmitter or wireless transceiver. For example, periodic transmission may be ordered to follow a time chart or time cycle where there are time periods where no data may be transmitted. The TX operation cycle may be lengthened or shortened or altered to conserve more energy in operation. Again statistical analysis of past operation may provide some predictive intelligence to determine what optimal duty cycle changes might be required to fine tune energy savings.

At step 1010, if it is determined to adjust or change transmission duty cycle, the TX cycle might be adjusted in step 1011. If at step 1010 it is determined not to make a change to TX duty cycle, the process may skip to step 1012. At step 1012 it may be determined whether to adjust or change the voltage level for the SPD processor. It is noted herein that the voltage level adjustment may be an adjustment to a voltage duty cycle where more than one voltage level is toggled according to a time frame. This feature may also be available for TX voltage levels.

If it is determined not to adjust or change voltage level fed to the processor at step 1012, the process may skip to step 1014. If it is determined to change or adjust the voltage level of the processor at step 1012 the adjustment may be made in step 1013. At step 1014 it may be determined whether to adjust or change the processor duty cycle, for example when the processor enters a sleep mode and wakes up again, when the processor enters self maintenance modes, etc. If it is determined at step 1014 to adjust or change the processor duty cycle, the duty cycle may be adjusted or changed at step 1015. If it is determined not to adjust the duty cycle of the processor at step 1014, the process may end for that cycle.

It is noted herein that these adjustment decisions may be made periodically at specific times for specific components regardless of what the current operational state of the SPD might be. In one embodiment the decisions are executed after each communications event that is transmitted or after a selected number of events are transmitted. Feedback relative to rate of energy drain on the SPD during operation may also be used to aid in the decision-making process. In this embodiment the decisions are made after each successful transmission of data. It is noted herein that a processor clock may be adjusted to insure that it is running at the lowest rate possible while still enabling tasks to be completed on time

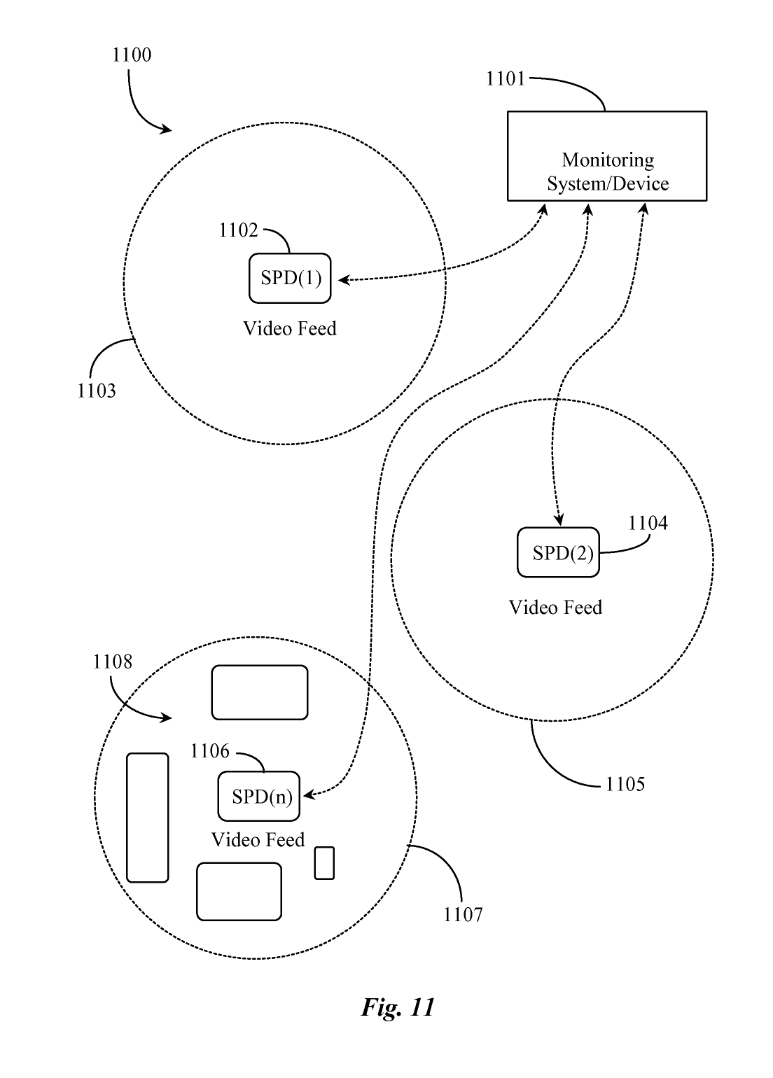

FIG. 11 is a block diagram 1100 depicting dynamic selection and enhancement of an active sensor feed at an SPD among multiple sensor feeds monitored. Diagram 1100 depicts a deployed SPD 1102 (SPD (1)), a deployed SPD 1104 (SPD (2)), and a deployed SPD 1106 (SPD (n)). In this example SPDs (1-n) may be mobile devices such as drones, for example, that are controlled wirelessly and that communicate sensor data wirelessly. A monitoring terminal or device 1101 controls the operation of the drones and receives sensor data, typically video and still images, for analysis and possible action by a drone operating team or individual.

SPD 1102 is collecting or capturing video data of an overflown area 1103. SPD 1104 is also capturing video of an overflown area 1105. SPD 1106 is capturing video of an overflown area 1107. Although the monitored areas are shown as separate, there may also be situations where the areas may overlap. Monitoring terminal 1101 is in constant contact with SPDs 1102, 1104, and 1106. In one embodiment a separate terminal may be used to operate (fly and maneuver) the drones while monitoring device 1101 is dedicated to receiving the video feeds from the drones simultaneously.

It can be seen in this example that drone or SPD 1106 has an overfly area that includes a complex of buildings 1108. Therefore SPD 1106 may be capturing video data that outranks or is more important than the video captured from the other drones with essentially barren overfly areas. The calculation of video feed importance may be driven by rules loaded onto the devices where a current view that has video data to disseminate becomes a dynamically important feed and may be treated differently than other currently non-productive video feeds from the drones overflying barren areas like 1103 and 1105. One way the more important feed is treated differently may be to display it in a much more prominent way at terminal 1101 and possibly capture the feed at higher resolution, color depth, frame rate, and possibly other enhancements such as magnification, slow motion, freeze frame, etc.

In one embodiment the operator of monitoring terminal 1101 may physically view all feeds in thumbnail or otherwise lower resolution frame rate color depth, etc. In this embodiment the operator may select a feed to display it more prominently on a monitor screen based on something witnessed by the operator in a lower resolution feed. The act of manual selection of one of the video feeds by an operator at terminal 1101 may trigger sending of a control signal to that SPD to maximize video capture resolution, frame rate, color depth, or other video feed quality parameters. In this way, SPDs that are capturing non-important data are minimized in energy use until they are selected for more detailed viewing.

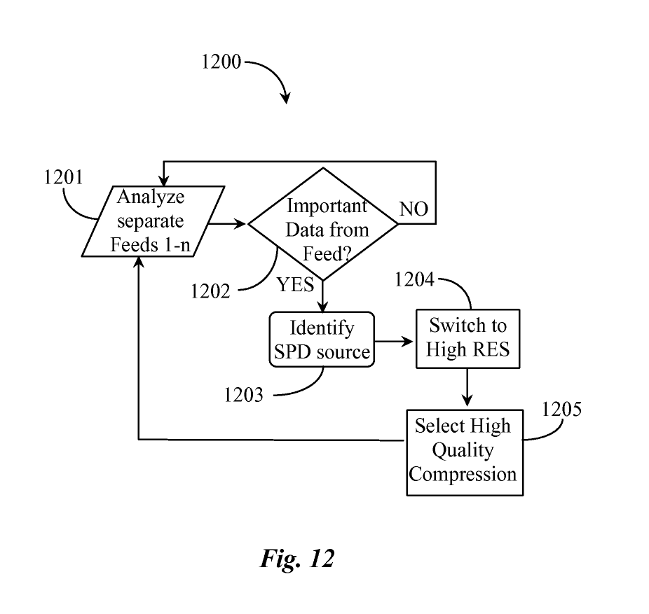

FIG. 12 is a process flow chart 1200 depicting steps for dynamic isolation of important sensor data among multiple incoming sensor feeds and enhancing that feed in communication. At step 1201 an operator viewing video feeds 1-n simultaneously at a monitoring terminal or device such as device 1101 described further above may analyze the separate feeds visually to determine if there might be important data being captured in any of the monitored feeds. At this step the feeds may be video or still camera feeds communicated at lower resolution, frame rate, color depth, and compression rate.

At step 1201 the operator may determine if there is important data in any of the feeds. Important data may mean any data that appears on the feed window of a video feed such as location information, presence of structures, presence of individuals, military targets, or any other relevant data that might indicate an importance for watching the feed more closely. Such criteria may be specified in advance by loading instruction onto the SPD. In one embodiment, the SPDs may notify the operator when they are about to film something that should be reviewed more closely and may cause the monitored feed to flash blink or otherwise indicate that closer viewing is warranted.

At step 1202 a determination may be made whether there is any important data being captured from a monitored data feed. If at step 1202 there is no data being captured that might include important data the process may resolve back to step 1201. Decision step 1202 may be executed at will by an operator at a terminal such as terminal 1101 described above or through periodic automated system checks for data indicating the possibility of important information being captured or that may be captured shortly as born out by location information or other intelligence. If it is determined that important data or a good possibility of such is indicated in one or more monitored feeds at step 1202, the operator or monitoring application may identify the SPD responsible for the feed at step 1203. At step 1204 the identification of the SPD performed manually or automatically triggers a control signal to the unit to switch to a higher resolution, frame rate, color depth, and higher quality compression rate for communication at step 1205.

In one embodiment an operator makes the determinations manually while actively viewing or sampling the lower resolution feeds being received. In another embodiment the SPDs are enabled to predict when higher value data may be captured by leveraging intelligence and other pertinent information such as location information, signs of motion, etc. This may result in some notification to the operator relative to context priority. The operator may then elect to view the indicated feed more closely and at higher resolution with additional features available. Depending on the size of the SPD fleet, any energy savings achieved during wireless transmission of the data is cumulative and lowers the cost of operation for the entire fleet in the case of drones for example.

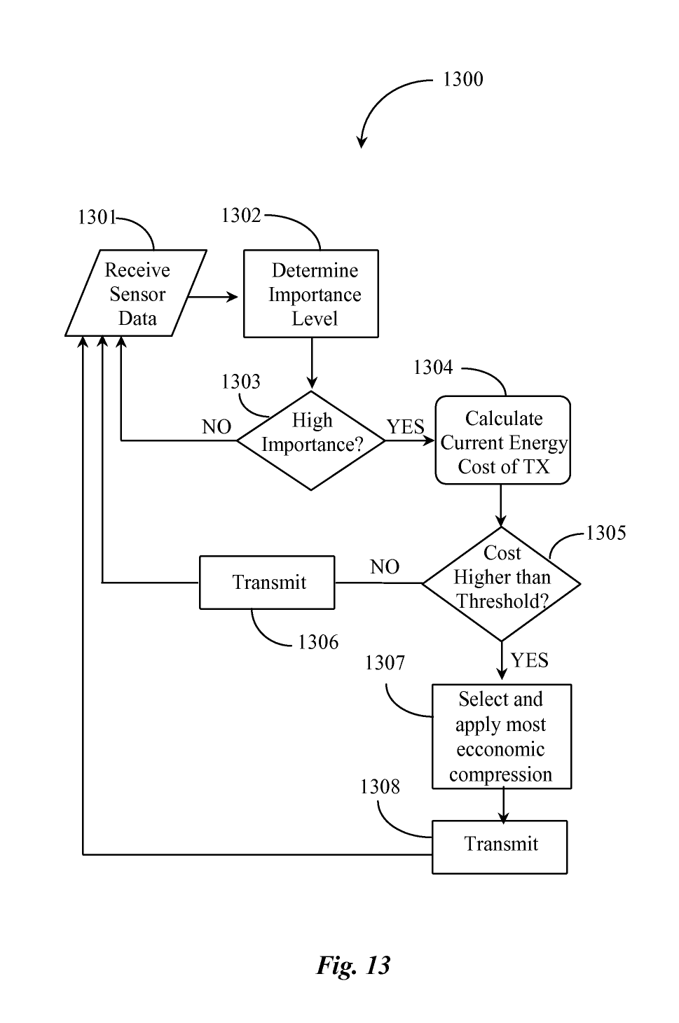

FIG. 13 is a process flow chart 1300 depicting steps for transmitting important sensor data from an SPD according to estimated cost of transmission of the data. At step 1301 an SPD may receive captured sensor data from an on-board or external sensor. At step 1302 it may be determined on the device whether the captured data is of a high importance sufficient for communication. This may be a prescreening of the captured data in light of rules including constraints and limitations.

In step 1303 it may be determined if the captured data is of a High importance based on prescreening at step 1302. If it is determined at step 1303 that the captured information is not of high importance, which would trigger communication of the data, the process may resolve back to step 1301. If it is determined that the captured data is of high enough importance to warrant transmission, the SPD may leverage instruction loaded into memory to calculate current energy costs relative to transmission of the data. At step 1305 it may be determined whether the calculation results in a value that exceeds a maximum threshold value determined for authorizing communication with moderate or no data compression.

If it is determined at step 1305 that the cost of transmission would not exceed a maximum threshold value the data may be transmitted at step 1306, and the process may resolve back to step 1301 for new data. In this case there may be 1 no compression used in transmission of the data because the cost did not exceed a threshold set for the device. If the cost is determined at step 1305 to be higher than the threshold, then the process may move to step 1307 for dynamic selection of a compression utility that may reduce the cost of transmission to a value beneath the maximum threshold for transmitting the data. The data is then transmitted at step 1308, and the process may resolve back to step 1301.

It may be that a cost estimate that falls within the acceptable cost range may still lead to compression of the data for transmission, but the exact compression utility may differ from one used to compress the data to reduce a higher estimate that came in above the maximum threshold. In one embodiment a decision not to compress or transmit the data may still be made if the compression utility for reducing the cost of transmitting the data adds too much energy drain to compress the data. The importance of the data may weigh heavily on the decision. For some context importance levels it may be acceptable to exceed normal accepted costs of transmitting the data especially if the data is extremely useful at the receiving end of the communications path.

In one embodiment one or more energy recovery routines might be provided to an SPD and executed by control signal to compensate for energy loss at one SPD due to transmission of important but heavy data. Such energy recovery may involve reducing duty cycles and voltage levels and resolution of data being captured by other SPDs in the same network for a period of time until the former energy drain has been compensated by saving an equal amount of energy over the rest of the units that are active.

In one embodiment power down and power up cycles may be enhanced to save energy. For example, if, after an initial activity there is always or usually a subsequent activity, power down may be delayed until completion of the second activity or task. Current context awareness and status or state of an SPD may be used to delay processing and communication to save energy in unnecessary activity. For example, if there is a significant change of the SPD's status, but the context is such that it is known that it is not time critical, the communication event corresponding to this status change might be delayed to avoid an inefficient power-down or power-up cycle issues. In one embodiment a criteria may be speed to execute an activity to minimize energy required during an increased wait time during a power down cycle. For example, if after an initial activity there is a subsequent activity at a predetermined time after the first activity, the execution of the second activity may be slowed down to conserve power while still processing the subsequent activity in the available time to avoid an inefficient power down or power up cycle.

Compression utilities may be of differing types for different data formats, for example lossless compression techniques may be used for data that cannot be adequately reduced by eliminating redundancy, like text for example. Losing data in compression might result in loss of meaning for the data to some extent. Other formats like video or still imagery may be compressed with specified loss of some data without it being noticed by an operator using a lossy compression technique. Some non-adaptive compression methods may include run length coding, which only provides data reduction for 1 percent of text. Delta encoding of text data may be pursued, however not effective for text, but may be very effective for slowly changing data.

Static Huffman coding may be used to compress text to about 34% reduction. Adaptive lossless compression techniques may include adaptive delta encoding for slowly changing data, Lemple-Ziv (-Welsh) may provide about 66% reduction for character coding of text. Adaptive arithmetic coding may be used, providing about 35% reduction for character coding of text. Some compression methods may leverage a combination of the above methods, for example delta encoding followed by Huffman coding. Other lossy data compression techniques may include A-Law audio coding of audio data, MP3 audio encoding, and MPEG video encoding. There may be compression methods available to the inventor that are not mentioned in this specification and that might be incorporated into the compression modalities afforded to an SPD.

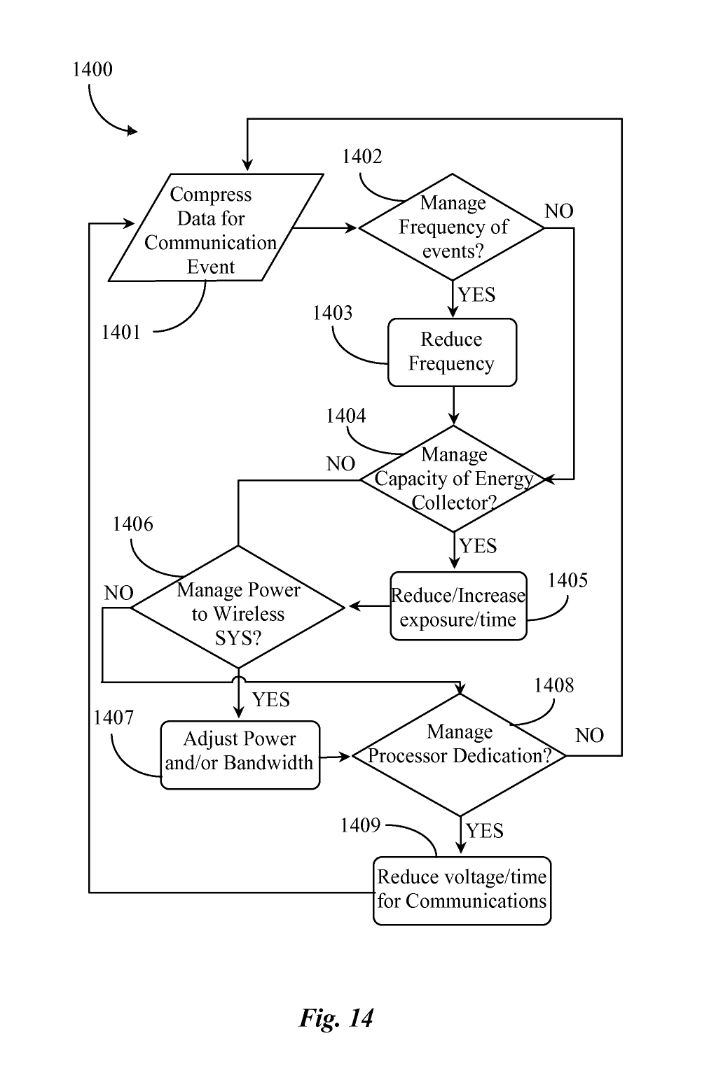

FIG. 14 is a process flow chart 1400 depicting steps for managing operation of on-board components of an SPD according to an embodiment of the present invention. At step 1401 an SPD compresses data for transmission in a communications event. It may be assumed that previous steps for qualifying the data for communication have been performed. It may also be assumed that the compressed data has been communicated in a communication event.

At any time during SPD operation, a determination may be made whether to manage the frequency of communication events sent from one or more SPDs. In this aspect it is assumed that transmission may be controlled to enable transmission of data only at stated time periods or frequency of send events. In one embodiment the stated frequency does not include control signals or notifications of state of the device.

If at step 1402 it is determined to manage the frequency of sends for communication events on an SPD, the process moves to step 1403 where the number of communication events that may be transmitted over a stated period of time, that is, the frequency of transmission, is reduced. For example the frequency may be reduced from 10 communication events permitted down to 4 communication events permitted for the same time period. It is noted that the frequency may also be increased. However, to save energy reduction of frequency of transmission may be appropriate at certain context levels of sensor data.

Managing communication frequency may also involve limits on the amount of data that may be communicated in an event or limiting the length of an event such as a streaming video monitoring session. In one embodiment, communication events may only be transmitted if there is significant change in sensor data or if there is a listener expecting or requesting the data.

All of the management functions in this process are meant to help reduce energy costs in transmission of sensor data at the local network level of the SPD, more particularly the cost of transmission of the data for the transmitting SPD to the first demarcation point of a larger network, if practiced on a larger network. Savings in energy may also be realized in communications over the larger data network, including over any proprietary networks that charge for bandwidth, time, etc. For example, a company operating a large fleet of SPDs over a broad region may see significant accumulative savings in energy costs as a result of implementation of the energy saving strategies and routines of the present invention. Smaller entities such as a local security camera network monitored on site without a larger data network involved saves energy within its own energy use scenario including management of energy collecting utilities, if any.

If at step 1402 it is determined not to manage frequency of communication events, the process skips to step 1404. At step 1404, it may be determined whether to manage the capacity of one or more than one energy collector associated with one or more SPDs in an SPD network. An example of an energy collector might be a solar panel or solar cell array adapted to collect and store solar energy on an SPD that may be used to power the device and charge device batteries or energy cells. Capacity refers to the maximum rate that the energy collector may collect and store energy on an SPD.

In other embodiments other types of energy collecting systems might be present to capture energy from the environment surrounding an SPD. Energy sources that may be harvested by an appropriate collector might include but are not limited to wired electrical connection(s) to power source(s) that may not always be present; AC Magnetic fields that may not always be present; AC Electromagnetic fields that may not always be present; and Photovoltaic cell(s) that generate electrical energy from light. Other collectors may include wind driven generator(s); Thermoelectric energy generator(s) that operate from a difference in temperatures that may be static or dynamic; and Kinetic (motion) energy generator(s). The latter may include Piezoelectric device(s), Magnetic/inductive energy generator(s) and The Kinetic (motion) energy generator(s), which may be driven by Physical actuation, Pressure fluctuations, Temperature fluctuations or Chemical-to-electricity generators.

If it is determined at step 1404 to manage capacity of the energy collector, the process moves to step 1405 where the solar apparatus may be managed, such as by reducing or increasing exposure time (solar), and/or reorienting collector panels to maximize or minimize the amount of energy collected in an exposure period, adding or removing cells, etc. In the case of other types of energy collectors other management tasks may be available such as managing direction of a wind-driven generator, for example. If it is determined not to manage the capacity of the energy collector, the process may skip to step 1406. At step 1406 a determination is made whether to manage the power and or other parameters of the wireless communications system linking the SPDs to a hub or first demarcation point of a larger network. The power level may be regulated by raising it or lowering it to the wireless communications system. The wireless communications system may, in some embodiments, also be configured for more or less bandwidth. Some communication systems may conserve the SPD's energy by transmitting at lower bandwidth at lower power for a longer period and some may conserve the SPD's energy by transmitting at higher bandwidth at higher power for a shorter period.

If at step 1406 it is determined not to manage power to the wireless communications system, the process may move to step 1408. At step 1408 it may be determined whether or not to manage processor dedication. If it is determined to manage processor dedication at step 1408 the clock speed might be changed, the voltage level to the processor may be regulated by raising or lowering the level at step 1409 as long as the clock speed is changed accordingly. In one embodiment the amount of time the processor may dedicate resources to processing (handling) and sending communication events may be raised or lowered. The process may then resolve back to step 1401 resuming normal operations. If it is determined not to manage processor dedication or voltage level, the process may skip back to step 1 resuming operation.

One with skill in the art will understand that energy management options available to regulate voltage levels, clock frequencies and frequencies of communications, etc. may be undertaken in any particular order or sequence during SPD operation or in standby mode without departing from the spirit and scope of the present invention. Other energy conservation methods may also be available, such as reducing the number of communications events for redundant data or reducing audio video files to display only changed data at higher resolution while redundant data is ignored or sent at very low resolution or low frequency requiring less bandwidth to communicate. In one embodiment, a low power proximity sensor may detect the presence of a person and may consume much less energy than a beacon transmitting multiple times per second. Using the context of whether a person is present and only triggering beacon type communication events when a person is nearby rather than at a fixed or scheduled transmission period can significantly reduce the amount of energy consumed by the SPD.

Other strategies for reducing energy consumed during wireless transmission and receipt of data may include reducing energy to transmit data based on knowledge of potential receiver(s) of the message and their proximity relative to the transmitting SPD. For example, if it is known that a receiving unit is fixed at close proximity to a transmitting SPD the energy required to be heard by the receiver may be reduced to a minimum level. A receiver that is known to be in close proximity to a transmitter may reduce energy to the minimum required to hear the transmitter. In another embodiment where the transmitter and receiver positions are known and in close proximity to one another, data rates may be increased in transmission without increasing power required or error rate. The increased data rate cuts the time of transmission at a fixed power level thereby conserving energy in transmission of the data. Moreover, in systems with multiple transmission paths through a wireless network routing instruction may be provided to identify the most cost efficient paths for routing.

It is noted herein that a routine for energy cost calculation for transmission of data may be a function of whether a node in the network is battery powered or not and may consider the remaining energy in an SPD when determining cost of transmission. For example, if the SPD is a mobile phone with multiple communications modes, WiFi may be used to transmit data at a lower power level than wireless cellular transmission, thereby minimizing energy drain on the battery of that SPD.

In a network having multiple node distribution the routing paths having lower cost transmission parameters may be detected and isolated for use. Transmission energy may be minimized by focusing transmission energy solely on the intended receiver. An example may be use of a directional radiation pattern (applies to any electromagnetic radiation, including light) to increase the radiant intensity at the intended receiver(s). These solutions may include either static or dynamic knowledge of the network location of the intended receiver(s). Focusing all transmitted light onto a receiver's light detector (optional sensor) enables lower power light transmission for the same range, data rate, and error rate. Another option is provision of a high gain radio frequency (RF) antennae pointed toward a know receiver's antennae enabling transmission at lower power levels.

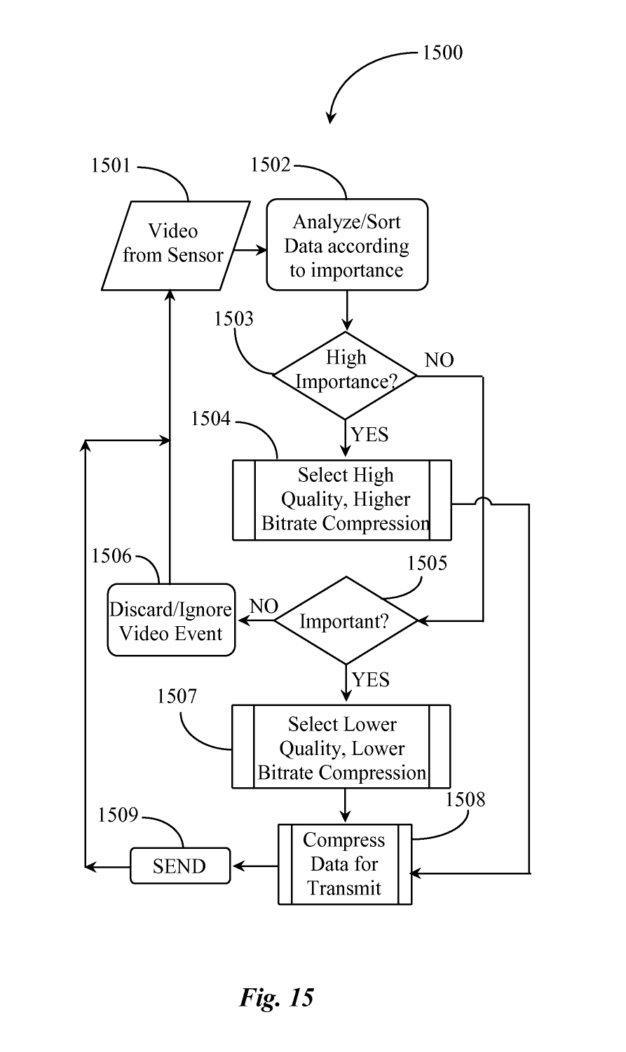

FIG. 15 is a process flow chart 1500 depicting steps for determining a type of compression for a video feed at an SPD based on importance of data. At step 1501, video from a video camera (sensor) is captured on an SPD. A video camera may be on-board an SPD or connected to an SPD via video cable. A video camera may also be an SPD, if implemented with abilities to follow the coded instructions and rules in embodiments of the invention.

At step 1502, the SPD analyzes the video and may sort the video data according to importance (context) of the data. Importance of video data may be determined on various abstract and more detailed or granular levels. For example, if the application is keyed to motion then sudden motion in a video may be tracked using appropriate instruction on the device and a motion event may be considered of higher importance than portions of the video data depicting no motion.

At step 1503 it may be determined whether there is data of high importance in the video feed. If at step 1503 it is determined that the video data contains data of high importance, the SPD event handler or other processing agent may select a compression method using high quality, higher bitrate compression for the important video data at step 1504 preserving higher resolution. Flow then goes to step 1508 where the data is compressed, then to step 1509, where the data is transmitted. Flow then resolves to step 1501.

If at step 1503 it is determined that there is no data of high importance in the video data the process may skip to step 1505. At step 1505 it may be determined if there is video data of importance. If at step 1505 it is determined there is no data of importance the process may skip to step 1506 where the system may discard or ignore the video data resulting in no communication of that data. In the case of no communication of the data, it may be assumed that no data of importance was captured. However, if at step 1505 there is data of lower importance, it may be compressed using a selected compression algorithm for lossy data compression where more data may be intentionally lost in compression. In one embodiment this might occur whether there was important data or not captured in the video.

At step 1508 the system may compress data for transmission using the selected compression of specified data in the feed. The compressed video data may be sent in step 1509. The process may then resolve back to step 1501 resuming operations. Data of high importance in a video feed may include motion, object presence in video, object size in video, object distance from camera in video, etc. Data of low importance in a video feed may include still video data showing no motion, background data or edge data, redundant data, etc.

In one embodiment more detailed processing may be supported for video analysis on an SPD. For example, in one embodiment, an SPD may, aided by SW and a database, attempt to identify or recognize an individual such as by facial features of the individual's face. In this case an unrecognized individual may be considered of low importance while a recognized individual signals high importance of the data. Many other possibilities exist depending upon the exact application. For example, in a drone feed, data depicting a structure or complex of structures on the ground may be considered of high importance while barren ground may considered of low importance. With multiple possible video feeds the sequence may be dynamic, such that one or more video captures may include data of higher importance and of lower performance. Video might be analyzed for patterns, object size, object location, motion, pattern recognition, facial recognition.

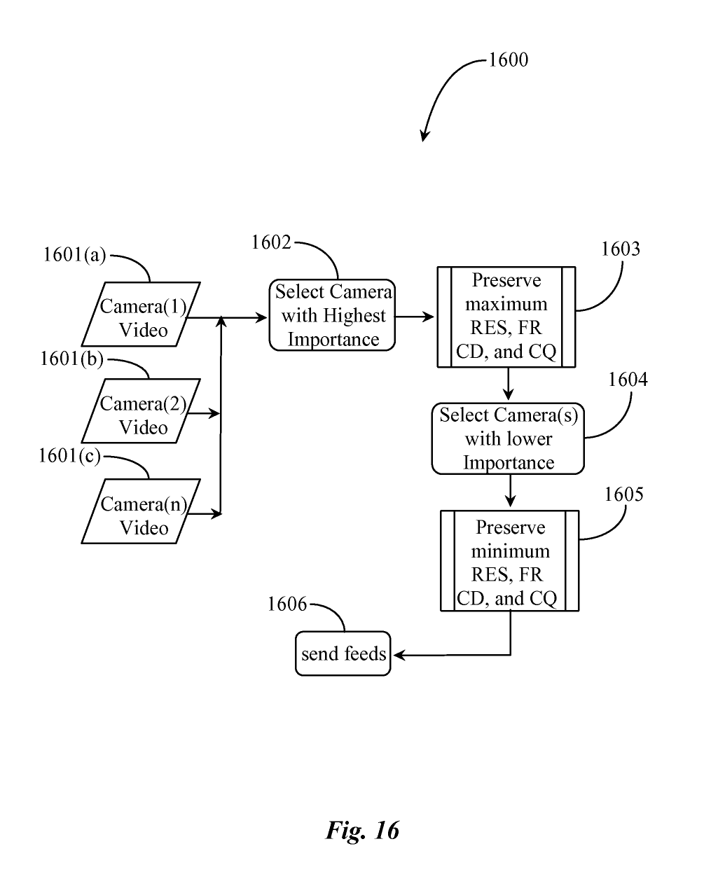

FIG. 16 is a process flow chart 1600 depicting steps for dynamic determination of a most important video feed from multiple feeds and enhancing that particular feed while preserving low enhancement for non-important feeds. At step 1601 (a-c), there may be multiple video cameras recording data. For example, three cameras may report to a single SPD or each camera may be part of an SPD or at least peripherally connected to an SPD. One example of this may be a drone operation including three or more drones flying and recording simultaneously.

In this example it may be assumed that a listener (drone monitor) may have to accept all of the transmitted video feeds but accepting them all at higher resolution may incur more energy costs. Therefore, the act of selecting the camera with higher importance functions to trigger enhanced video performance for that particular camera. At step 1602 a video camera with highest importance in the immediate time frame is selected. The act of selection of the camera having higher performance may occur at the video monitoring end of the connection between the cameras and the monitoring terminal. In one embodiment, as soon as a camera records data of high importance, it may be dynamically promoted on-board the device aided by SW that recognizes the important data.

In either event, at step 1603 the SPD may preserve or initiate maximum resolution, frame rate, color depth, and compression quality for video from the camera. In this way a person monitoring all of the feeds may focus on the higher resolution feed or feeds instead of the lower resolution feeds. At step 1604 the camera feeds that are of lower importance may be selected by default (all feeds not deemed important). At step 1605 those feeds with lower importance may be preserved at minimum resolution, frame rate, color depth, and compression quality. At step 1606 the video feeds may be compressed accordingly (high or low importance) and sent or transmitted from the host SPDs.

It is noted herein that selection of a video feed based on importance of data in the feed may be achieved after the video is compressed and sent to a monitoring terminal in cases where all active video feeds must be transmitted. An operator at the monitoring terminal may select a video feed being displayed, selection causing a remote control signal to select the feed at the host SPD for importance, thus triggering changes is resolution, frame rate, or other features of the feed to improve visual monitoring at the monitoring terminal of that particular feed over the feeds of lower importance. It is also noted that more than one feed of multiple feeds may be selected in overlapping fashion for state change in quality of recording and transmitting of the selected feeds.

In some video systems a motion sensor is triggered before video is recorded. In this case the importance of the feeds rests on what triggered the video. The size of the subject or position of the subject in the video recorded when the video first appears may be criteria for selecting the feed as more important than other triggered feeds.

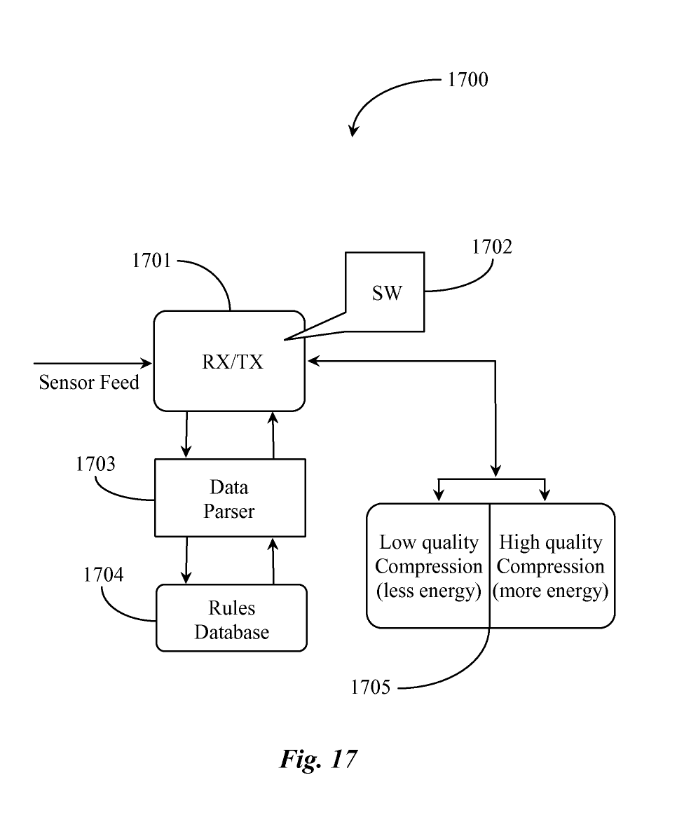

FIG. 17 is a process flow chart 1700 depicting steps for dynamic determination of high or low quality data compression on an SPD based on important data from the feed. In this example a sensor feed is received at a host SPD at step 1701 running SW 1702. It may also be a feed taken from the SPD using an on-board video camera without departing from the spirit and scope of the invention. SW 1702 is adapted to parse the sensor reading using a data parser 1703 in conjunction with a rules database on the device. The sensor data may be text readings representing any type of sensed conditions at the host SPD.

In this example the device determines the importance of the sensor data before transmission and selects a low quality compression modality (less energy) or a high compression modality (more energy) to compress the data for send at step 1705. It may also be that the data in the sensor feed is not recognized as important data, so there may be no transmission of the sensor data until an important change in the data is picked up at the SPD host of the sensor. For example, a sensor reading a heart rate for a patient may produce data that will not be communicated unless the heart rate pattern deviates from a normal range for more than a certain period of time. Once the data is communicated, it means a serious event is in progress or has occurred. It is also noted herein that there may be more than one level or tier of importance for sensor data where each tier of importance of the data calls for a different compression or processing algorithm to compress the data before communication. In the above example heart rate data initially outside of the normal range may be stored but not transmitted unless the heart rate data deviates for more than a certain time.

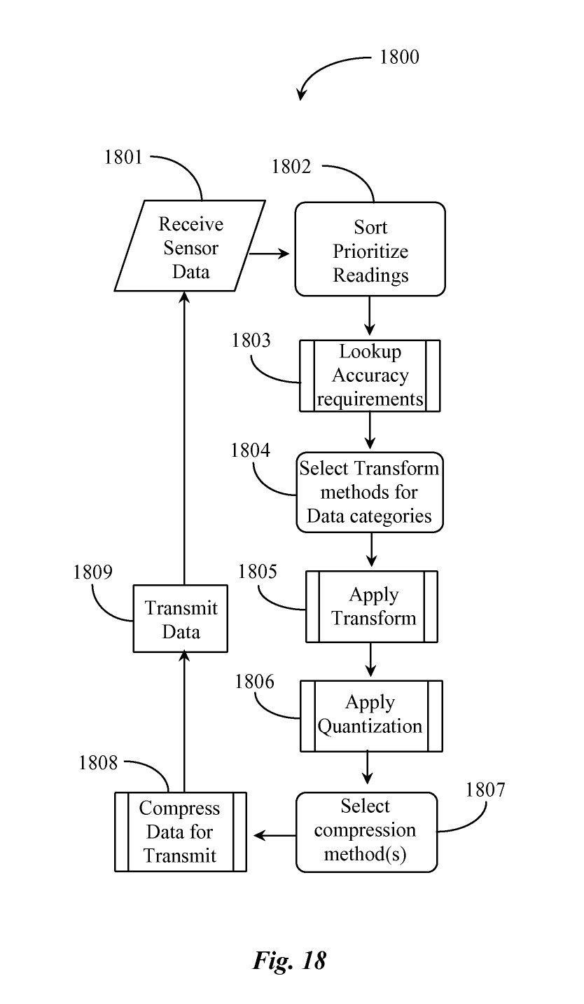

FIG. 18 is a process flow chart 1800 depicting steps for dynamic determination of a transform method followed by quantization of sensor data from one or more sensor feeds at an SPD based on accuracy requirements of the data. At step 1801 an SPD receives sensor data from an on-board sensor or a remote sensor communicating with the SPD wirelessly or via cable. At step 1802 the sensor data may be sorted and prioritized. At step 1803, the event handler or other processing agent may look up accuracy requirements for the sorted data categories in the sensor data.

Depending upon accuracy requirements, the processing agent or event handler may select particular data transform functions for the different categories of sensor data in step 1804. One with skill in the art of statistics may realize that there are many possible transform functions available to the inventor for transforming data values. The transforms are applied to the data at step 1805. It is also possible that a determination not to use a transform function on sensor data may be made.

In step 1806 quantization may be applied to any of the sets of transformed sensor data to limit variance of the data. This state may be optional or conditional in some embodiments. At step 1807 the processing agent, such as an event handler, may select one or more compression modes or methods in step 1807 to compress the sensor data for transmission. At step 1808 the processing agent or event handler compresses the data for sending in one or more communications events. The process may resolve back to step 1801 resuming operations. It is noted herein that quantization might be used to compress sensor readings to data values corresponding to sensor accuracy but not to sensor resolution.

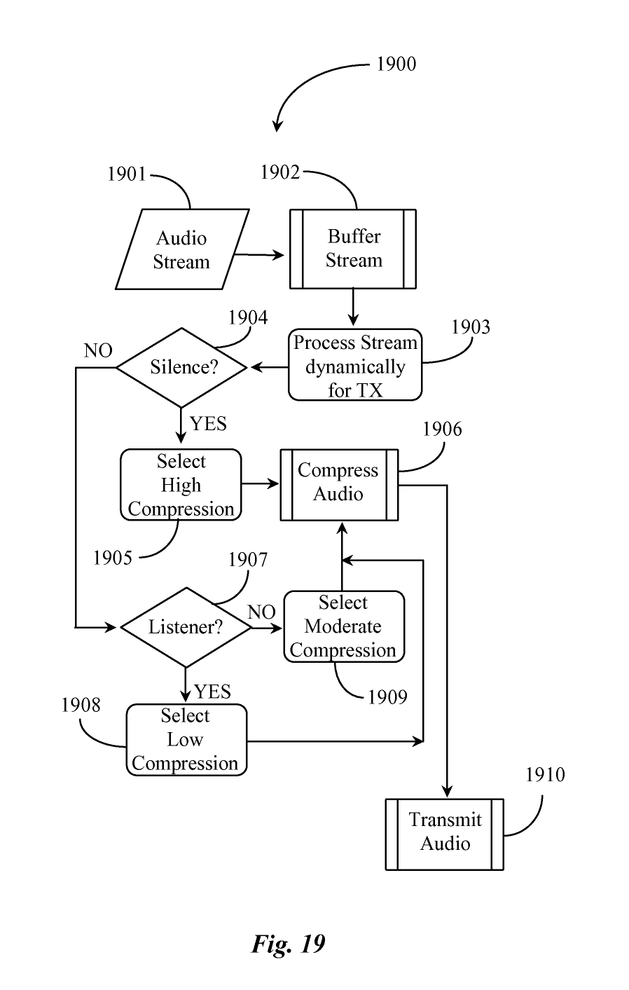

FIG. 19 is a process flow chart 1900 depicting steps for dynamic determination of compression of an audio feed at an SPD based on silent portions in the feed and whether there is an active consumer of the feed. In this example, audio data is recorded or sensed and a recorded audio stream is available at an SPD in step 1901. In step 1902 the audio stream may be buffered to undergo near real-time processing. In one embodiment the audio stream is a music stream. In another embodiment the audio stream is a voice or voices of persons near the recording device. In one embodiment the audio may be a tone, a series of differing tones, or any other sounds that might be recorded.

In step 1903, the processing agent “listener” may process the stream for silence and for audio data. For example in voice recordings periods of silence may be recorded. In music recording there may also be periods of silence or other forms of audio such as announcements or introductions between songs. In step 1904, the processing agent or listener determines if there is silence. If at step 1904 there is silence, the event handler may select a low quality, high compression modality in step 1905 and compress the silent portions of the audio stream for transmission in step 1910.

If at step 1904 if there is no silence, the system might determine if there is a “listener” for the data or if someone requested the data. If at step 1907 there is no one listening for or expecting the data, the event handler or processing agent may select a moderate quality, moderate compression modality for compressing the data at step 1909. In this case the process moves back to step 1906 where the data is compressed and to step 1910 where it is transmitted.

If there is a listener for that data at step 1907 then the event handler may select a high quality, low compression modality in step 1908 to compress the data for sending. The data may be compressed at step 1906 and transmitted at step 1910.

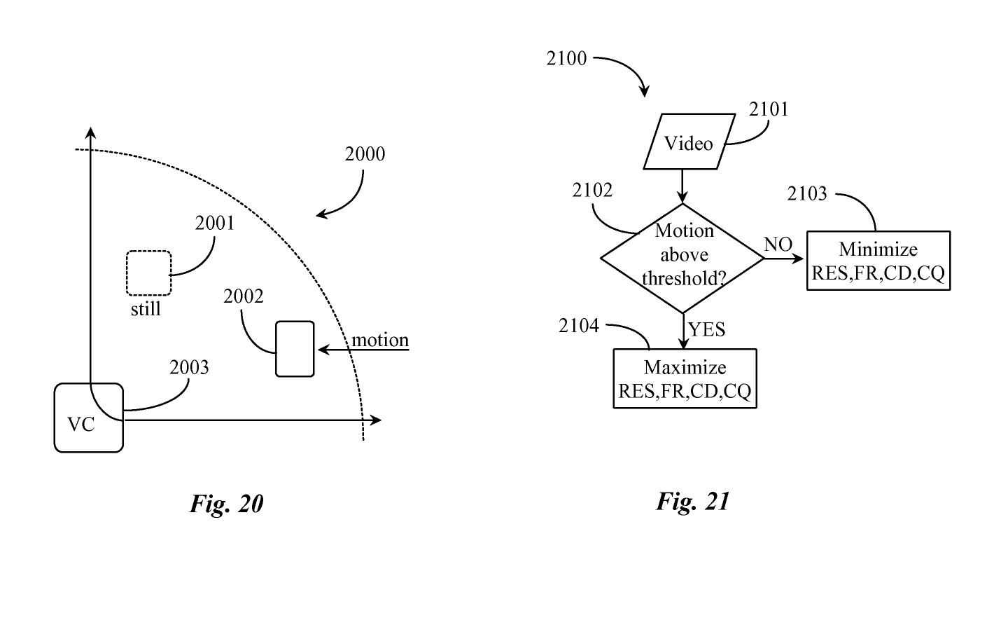

FIG. 20 is a block diagram 2000 depicting on-board determination and isolation of motion in a video feed at an SPD. In this example a video camera-enabled SPD 2003 has an area of video coverage represented by double arrow directional line with a broken boundary line intersecting the double arrow line. In this embodiment importance of the video data relates more to motion in the video as opposed to anything else that may be in the video.

There are two object depicted within the video coverage area. One object 2001 is still in the video feed and therefore is not deemed important in this feed. The other object 2002 is in motion in the video feed and has entered the coverage area. Object 2002 may be tracked in the video and isolated from the rest of the video data. The motion may automatically trigger tracking software and may initiate isolation of the video data showing the object in motion. At least the video data depicting object 2002 in motion may be compressed and transmitted at higher resolution, frame rate, color depth, and compression quality. Other features may also be activated like freeze frame, slow motion, magnification, loop segment, etc. Some of these features if available may be automatically triggered to occur in the feed being reviewed at the receiving end.

FIG. 21 is a process flow chart 2100 depicting steps for dynamic determination of resolution, frame rate, color depth, and compression quality at an SPD based on detecting motion in a video feed above a threshold set for that sensor. Process flow chart 2100 may depict a process for dynamic compression of video data based on the importance of motion detected in the video. At step 2101 video is received at or otherwise recorded at an SPD such as SPD 2003 of FIG. 21. At step 2102 a determination may be made whether motion is detected in the video at or above a motion threshold. In one embodiment a separate motion sensor might be used to determine if there is motion being captured on the video. In another embodiment SW on the SPD determines if there is motion of any objects on the video. In step 2102 if it is determined that there is no motion in the video at or above a motion threshold value, the video resolution, frame rate, color depth, and compression quality may be maintained at a minimum so as to cost less in transmission at step 2103. In this case the video with little or no motion is not important in monitoring. However it may be required policy that an operator views the no-motion feed, and it may be sent at minimum resolution etc. so it does not impose large energy drain on the SPD sending the video data.

The command or settings change to the video camera may be triggered by an external signal sent from a video monitoring terminal where all collected feeds are viewed. The command or signal may also be instruction that is preloaded on the SPD and triggered by SW that detects motion in the video. If there is motion in the video feed above a preset threshold at step 2102 the processing agent or event handler may dynamically maximize the resolution, color depth, frame rate, and compression quality of the entire feed or of a portion of the feed where the motion is occurring in step 2104.

In one embodiment a motion threshold value may include object direction and or trajectory, object velocity, object size, object shape, etc. Any object in motion that does not meet the requirements of the threshold value might be ignored. An object that meets or exceeds the threshold may be considered important enough to track and to try and determine what the object is in terms of threat, etc. or depending on the application. In one implication multiple objects in motion may be recorded whereby one or more of those may be deemed more important than others by virtue of motion characteristics, size characteristics, density characteristics, or other physically trackable parameters.

In one embodiment some video data may be purged or otherwise ignored from a video feed but simulated or reconstructed at the receiving end of transmitted video data from descriptive data or markup language to simulate the actual video data purged or ignored while other video data in the same feed is transmitted for the important parts of the video.

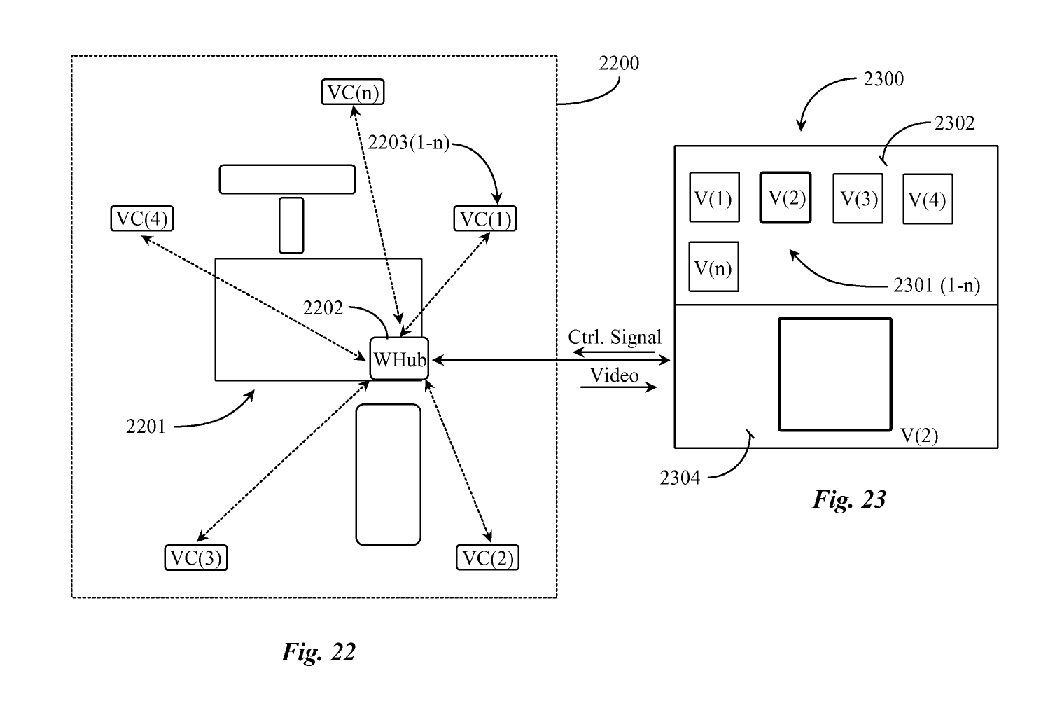

FIG. 22 is a block diagram depicting a complex of buildings 2201 within a monitored area 2200 defined by a broken rectangle. Building complex 2201 may be under video surveillance or monitoring, for example, by fixed SPDs (video enabled) 2203 (1-n) strategically placed about the perimeter 2200 in positions such as on pole to view building complex 2201 and the surrounding area. SPDs 2203 (1-n) each communicate with a wireless hub or router 2202.

FIG. 23 is a block diagram depicting dynamic determination of an active video feed on a monitor screen 2302 from one of SPDs 2203 (1-n) and isolating and displaying the feed at high resolution, frame rate, and color depth. Referring back to FIG. 22, hub or router 2202 may be connected directly to a monitoring terminal via wireless communication network as depicted by a double arrow between hub 2202 and the monitoring terminal 2300.

Referring now back to FIG. 23, a monitor screen 2302 displays video feeds 2301 (1-n) representing feeds from SPDs 2203 (1-n) of FIG. 22. In this example, the operator of screen 2302 may be a security person. Screen 2302 displays active video feeds in relatively small low-resolution viewing windows. The monitor screen may be split to provide screen 2304 containing a video feed 2301 (2) representing video captured by SPD 2203 (2) of FIG. 22. In this embodiment the operator may have selected V(2) displayed in screen 2304 from screen 2302 based on observation of something like motion, for example, occurring in the lower resolution version.

In this embodiment the act of the operator's selection of video feed V(2) may automatically send a control signal to hub 2202 of FIG. 22. The signal or message may provide instruction to switch to a higher resolution, frame rate, color depth, and compression quality for V (2) from SPD 2203 (2) or video camera 2 (VC (2). Once motion has been detected in a smaller viewing window the operator may simply click anywhere in the window to expand the window in screen 2304 sending the signal to hub 2202, which in turn forwards the configuration change to SPD 2203 (2) where it may be implemented. VC (2) provides recording thereafter at higher or maximum resolution, frame rate, color depth and compression quality. This may occur as long as the video feed is being displayed in screen 2304 of FIG. 23.

The operator may also deselect the video feed V (2) in favor of another feed or simply return it back to smaller form in screen 2302 by such as drag and drop using a computing input device like a mouse. The act of deselection of video feed V (2) by the operator may trigger sending of a second control signal or message from the monitoring terminal to hub 2202 of FIG. 22 to return to default video settings. Hub 2202 may forward the instruction wirelessly to SPD 2203(2) or VC(2).

In this embodiment the monitoring terminal may be on site and communicating with hub 2202 via wireless communication. In one embodiment the terminal may be tethered to hub 2202 by data line. There may be more than one terminal monitoring video feeds 2203 (1-n) without departing from the spirit and scope of the invention. It is noted herein that dynamic control of sensor resolution by feed selection is not limited to video data. It may also apply to video/audio data, audio data, still imagery, and other data where resolution may refer to level of inclusion of detail of data in a sensor stream of potentially changing values.

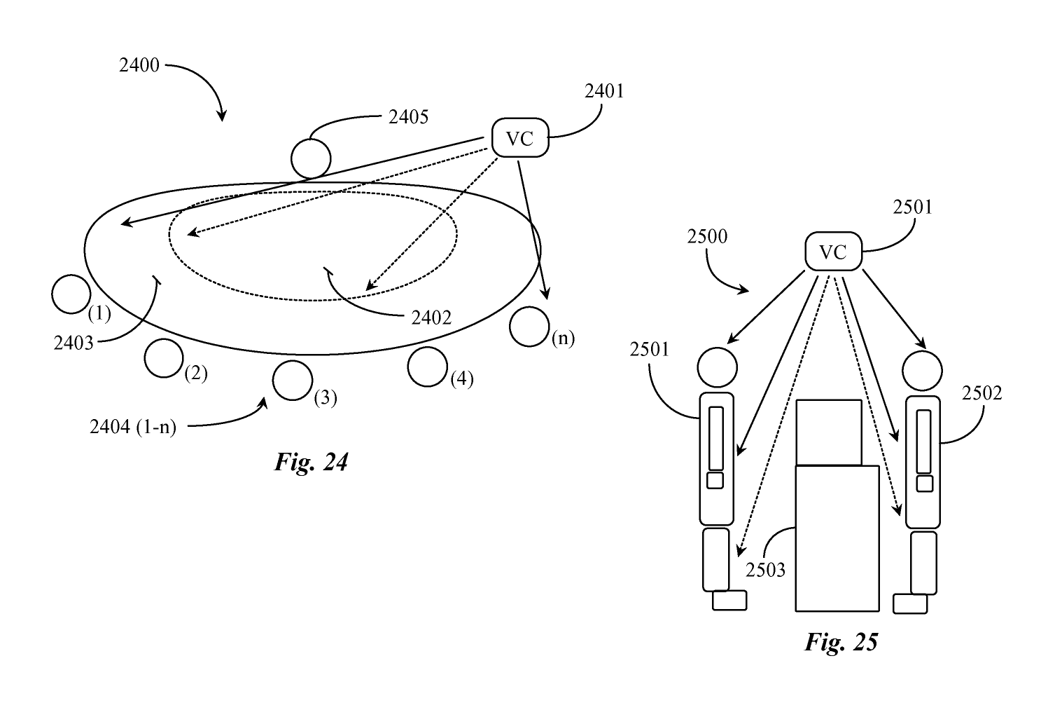

FIG. 24 is a block diagram depicting isolated coverage of regions of an overall video-monitored area 2400 for post video assignment of resolution, frame rate, color depth, and compression quality at an SPD before communication. Area 2400 may be a relatively small video coverage area such as a gaming table at a casino for example. Areas such as these are routinely monitored by video.

In this example an overhead mounted SPD (video enabled) 2401 records active video of action at the table during gambling activities. Gamblers 2404 (1-n) are seated about the table engaged in play. A dealer 2405 may deal a card game such as poker or black jack. In this example, table region 2400 may be divided into two regions covered by VC 2401 such as a region 2402 and a region 2403. Region 2403 is where patrons 2404 (1-n) may be observed in terms of physical activity of gambling and may be considered an important region to get high quality video of. Region 2402 may be a lesser important region where the dealer operates and may be less of a security concern than region 2403. The context of the data then is that watching patron activity is more important than watching the dealer. In this example instruction for which video context is important may be preloaded into VC 2401 such that all data captured in video region 2403 be recorded at a higher resolution and all video data captured in region 2402 be recorded at a much lower resolution to save energy in communicating the feeds to a monitoring terminal for example.

In one embodiment video or still image data from a single source may be viewed by one or more observers. The focus points of the observers may be used as the context of the value of the data in the region of the focus points. Data in the region of the focus points may be dynamically selected as high value data to be sent with higher resolution, frame rate, color depth or compression quality while the rest of the video data may be sent at a lower resolution, frame rate, color depth or compression quality in order to minimize the amount of data sent and to minimize the energy expended.

In one embodiment VC 2401 may record all of the data at a higher resolution then preserve the resolution of the more important data and lower the resolution of the data recorded in the lesser important region before sending the data to a monitoring terminal. In another embodiment there may be two separate feeds isolated from one another where one camera covers region 2402 at a lower resolution and another camera captures region 2403 at a higher resolution. In this case frame rates, color depth, and compression quality may be different for data recorded in each region.

FIG. 25 is a block diagram depicting isolated coverage of regions of an overall video-monitored area 2500 for post assignment of resolution, frame rate, color depth, and compression quality on an SPD before communication. Area 2500 may represent a transaction space such as a checkout counter having a sales terminal or register apparatus 2503. In this example an SPD (video enabled) 2501 is mounted overhead and at an angle such as to record video of a customer service person 2502 and a transacting customer 2501.

In this example it may be more important to get better resolution in video coverage from the general waist level up for customer 2501 and service person 2502 whereas the area below the waistline is of less importance to get full resolution. The instruction detailing which regions or portions of a covered area are more important in the feed may be preloaded onto the SPD 2501. In one embodiment all of the area is initially recorded at high resolution but only the data depicting the transacting individuals from the waist up is transmitted at high resolution. In another embodiment the video camera may have a capability of recording the areas separately at different resolutions.

In the examples of FIG. 24 and FIG. 25 video coverage areas are divided into areas of more or less context importance resulting in more or less resolution and detail of the data preserved for transmission. In each case there may be many video-enabled SPDs such as one for each table in a casino or one for each isle in a large grocery outlet.

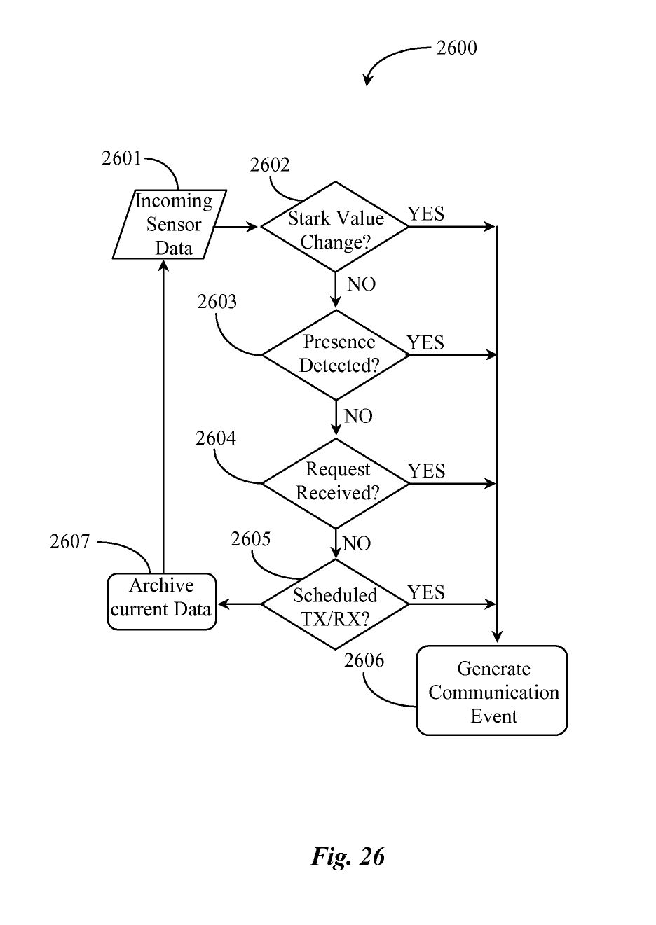

FIG. 26 is a process flow chart 2600 depicting steps for generating a communication event from an SPD based on multiple detected criteria according to an embodiment of the present invention. At step 2601 sensor data becomes available to an SPD such as from one or more on-board sensors or from one or more external sensors. At step 2602 a determination is made whether the data represents a substantial or noticeable value change in data from that sensor or sensors as detected through parsing the data at the device before communication of data. If it is determined at step 2602 that there is a significant or abrupt value change detected in the sensor data, the process may skip directly to step 2606 wherein a communication event may be created to communicate the sensor data reflecting the value shift.

If at step 2602 there is no change in data, it might be determined at step 2603 if there is a presence detected in terms of an operator at a monitoring terminal (receiving end). If it is determined at step 2603 that a presence is detected such as an active operator then the process may skip to step 2606 whereby a communication event may be generated to send the sensor data. If it is determined in step 2603 that no presence is detected a determination may be made at step 2604 whether a request for data has been received from a monitoring terminal or system. A request for data may be from a live operator or from an automated system monitoring the data.

If it is determined a that a request has been received for sensor data then the process may skip to step 2606 whereby a communication event may be generated to transmit the data. If it is determined at step 2604 that no request for data was received, a determination may be made at step 2605 whether there is a scheduled time for sending sensor data. If at step 2605 there is a scheduled time for transmission and or receipt of data, the process may move to step 2606 whereby a communication event may be generated to send data. If it is determined that no scheduled transmission is detected the system may archive or purge the data collected. The process may begin again at step 2601 for a next batch of data or for other media monitoring scenarios.

It will be apparent to one with skill in the art that the energy conserving system of the invention may be provided using some or all of the described features and components without departing from the spirit and scope of the present invention. It will also be apparent to the skilled person that the embodiments described above are specific examples of a single broader invention that may have greater scope than any of the singular descriptions taught. There may be many alterations made in the descriptions without departing from the spirit and scope of the present invention.

It will be apparent to the skilled person that the arrangement of elements and functionality for the invention is described in different embodiments in which each is exemplary of an implementation of the invention. These exemplary descriptions do not preclude other implementations and use cases not described in detail. The elements and functions may vary, as there are a variety of ways the hardware may be implemented and in which the software may be provided within the scope of the invention. The invention is limited only by the breadth of the claims below.

1. A device comprising:
a processor;
a memory system coupled to the processor;
an on-board, rechargeable power supply;
one or more data-capture mechanisms;
circuitry enabling wireless data transmission on a network;
rules and criteria stored in the memory system regarding characteristics of data; and
coded instructions executing on the processor from a non-transitory physical medium, providing a process wherein data captured by the one or more data-capture mechanisms is examined applying the rules and criteria regarding characteristics of data, and data is transmitted via the network by specific processes selected depending on the characteristics, the specific data transmission processes enabled to minimize power consumption from the on-board power supply.

2. The device of claim 1 wherein the examination results in portions of data indicated as having different levels of importance.

3. The device of claim 2 wherein alternative modes of data compression are selectable, different modes having different power-consumption characteristics, and wherein data indicated as having lesser importance is either discarded or transmitted by one or more data transmission processes with a low power consumption characteristic.

4. The device of claim 3 wherein one or more of resolution, color depth, and frame rate are altered to reduce power consumption for data of low importance.

5. The device of claim 1 wherein circumstances of data capture are considered in examination of captured data as well as characteristics of the captured data, and specific data transmission processes are selected depending on the circumstances of data capture.

6. The device of claim 5 wherein the circumstances of data capture comprise specific time or duration of data capture.

7. The device of claim 2 wherein the one or more data capture mechanisms comprise a video camera, and level of importance of data is determined by specific image characteristics in different portions of a video frame.

8. The device of claim 1 further comprising circuitry for two-way communication with remote nodes on the network, and wherein execution of the coded instructions seeks presence of a listener for data at a remote node addressed for data transmission, and circumstances of transmission are determined according to the presence or absence of a listener.

9. The device of claim 1 further comprising circuitry for two-way communication with remote nodes on the network, and wherein instructions received from a remote node on the network are followed in selecting circumstances of data transmission.

10. The device of claim 1 wherein the specific data transmission processes include altering frequency and/or duration of transmission.

11. A method comprising:
capturing data by one or more data-capture mechanisms coupled to a device having a processor, a memory system coupled to the processor, an on-board, rechargeable power supply, circuitry enabling wireless data transmission on a network, rules and criteria stored in the memory system regarding characteristics of data, and coded instructions executing on the processor from a non-transitory physical medium;
examining the captured data applying the rules and criteria regarding characteristics of data; and
transmitting data via the network by specific processes selected depending on the characteristics, the specific data transmission processes enabled to minimize power consumption from the on-board power supply.

12. The method of claim 11 wherein the examination results in portions of data indicated as having different levels of importance.

13. The method of claim 12 wherein alternative modes of data compression are selectable, different modes having different power-consumption characteristics, and wherein data indicated as having lesser importance is either discarded or transmitted by one or more data transmission processes with a low power consumption characteristic.

14. The method of claim 13 wherein one or more of resolution, color depth, and frame rate are altered to reduce power consumption for data of low importance.

15. The method of claim 11 wherein circumstances of data capture are considered in examination of captured data as well as characteristics of the captured data, and specific data transmission processes are selected depending on the circumstances of data capture.

16. The method of claim 15 wherein the circumstances of data capture comprise specific time or duration of data capture.

17. The device of claim 12 wherein the one or more data capture mechanisms comprise a video camera, and level of importance of data is determined by specific image characteristics in different portions of a video frame.

18. The method of claim 11 further comprising circuitry for two-way communication with remote nodes on the network, and wherein execution of the coded instructions seeks presence of a listener for data at a remote node addressed for data transmission, and circumstances of transmission are determined according to the presence or absence of a listener.

19. The method of claim 11 further comprising circuitry for two-way communication with remote nodes on the network, and wherein instructions received from a remote node on the network are followed in selecting circumstances of data transmission.

20. The method of claim 11 wherein the specific data transmission processes include altering frequency and/or duration of transmission.
